(19) United States
(12) Patent Application Publication
(10) Pub. No.: US 2026/0321654 A1
(43) Pub. Date: Oct. 15, 2026

(54) ELECTRODE, ELECTRODE COMPOSITE BODY, SECONDARY BATTERY, AND METHOD FOR MANUFACTURING ELECTRODE

(71) Applicant: CANON KABUSHIKI KAISHA, Tokyo (JP)

(72) Inventors: KENTA KUBO, Kanagawa (JP); HIROSHI TANIUCHI, Kanagawa (JP); HIROKAZU USAMI, Kanagawa (JP); IKUO NAKAZAWA, Kanagawa (JP); YOHEI MASADA, Tokyo (JP); TAKAHARU AOTANI, Tokyo (JP); MASAKI YAMADA, Shizuoka (JP); HIROAKI KOMATSU, Shizuoka (JP); KENTA MATSUNAGA, Shizuoka (JP)

(21) Appl. No.: 19/466,707

(22) Filed: Feb. 2, 2026

Related U.S. Application Data
(63) Continuation of application No. PCT/JP2024/026588, filed on Jul. 25, 2024.

(30) Foreign Application Priority Data
Aug. 10, 2023 (JP) 2023-131271

(51) Int. Cl. H01M 4/62; H01M 4/04; H01M 4/139; H01M 10/052; H01M 10/0562; H01M 10/0565

(52) U.S. Cl. CPC H01M 4/624; H01M 4/0433; H01M 4/139; H01M 10/0562; H01M 10/0565; H01M 10/052

(57) ABSTRACT

Disclosed is an electrode which is to be applied to a secondary battery, the electrode including active material particles and a conductive resin. The active material particles each have an inner surface, and the conductive resin is positioned so as to be in contact with the inner surface.

### CROSS-REFERENCE TO RELATED APPLICATIONS

This application is a Continuation of International Patent Application No. PCT/JP2024/026588, filed Jul. 25, 2024, which claims the benefit of Japanese Patent Application No. 2023-131271, filed Aug. 10, 2023, both of which are hereby incorporated by reference herein in their entirety.

### BACKGROUND

### Field of the Technology

The present disclosure relates to an electrode for use in a secondary battery, an electrode composite, a secondary battery, and a method for manufacturing an electrode.

### Description of the Related Art

Generally, a secondary battery consists of electrodes (positive and negative electrodes) and an electrolyte. Charging and discharging occur through the movement of ions between the electrodes through the electrolyte. Such secondary batteries are used in a wide range of applications, from small devices such as mobile phones to large devices such as electric vehicles. Therefore, further improvements in secondary battery performance are required. In recent years, so-called all-solid-state batteries, which use inorganic solid electrolytes as the electrolyte, have been actively researched and developed. All-solid-state batteries are expected to improve safety and increase the capacity and power output of secondary batteries by replacing conventional organic electrolytes with solid electrolytes.

However, in all-solid-state batteries, the expansion and contraction of active material particles during the ion penetration and release process in the electrodes easily disrupts contact between the electrolyte and active material particles. The resulting problem is that the penetration and release of ions, such as lithium ions, into and from active material particles in all-solid-state batteries is blocked, increasing electrode resistance and significantly reducing the chargeable/dischargeable current, i.e., the so-called output characteristics. To address this issue, a technique has been developed that incorporates a lithium ion conductive polymer, which is more flexible than electrolyte particles, inside the electrode.

Japanese Patent Laid-Open No. 2002-373643 discloses an electrode in which the outer surface of active material particle is partially coated with a lithium ion conductive polymer.

### SUMMARY

However, the present inventors have discovered that simply partially coating the outer surface of active material particles with a polymer is insufficient to improve the diffusibility of lithium ions within the electrode. This is believed to be due to the following reason.

Thus, an active material particle within an electrode expands and contracts during charge and discharge. Furthermore, neighboring active material particles also expand and contract similarly. Therefore, if the outer surface of active material particles is only partially coated with a polymer, the diffusion paths of lithium ions, which consist of the polymer between the active material particles and the electrolyte particles, are likely to be blocked. Furthermore, in the active material particle disclosed in Japanese Patent Laid-Open No. 2002-373643, the surface of the active material particle is partially coated with both polymer and electrolyte particles. Therefore, contact between the polymer and the electrolyte particles is also limited, and this contact is easily blocked by the expansion and contraction of the active material particles. This tends to restrict the diffusion of lithium ions between the active material particle and the polymer. As a result, even with solid electrolytes, which generally have higher ionic conductivity than polymers, the effect of ion diffusion is likely to be reduced.

Furthermore, Japanese Patent Laid-Open No. 2002-373643 discloses a mechanical milling method, chemical coating treatment, etc. as methods for partially coating the surface of active material particles. However, these treatment methods make it difficult to achieve uniform coating areas and thicknesses for each particle, resulting in problems with reproducibility as an electrode manufacturing method.

The present disclosure provides an electrode that can mitigate expansion and contraction of active material particles and suppress a decrease in battery output when used in a secondary battery. The present disclosure also provides an electrode composite including the electrode of the present disclosure. Additionally, the present disclosure provides a secondary battery in which a decrease in battery output is suppressed. Furthermore, the present disclosure provides a method for manufacturing an electrode with high reproducibility.

An electrode according to one aspect of the present disclosure is characterized by that the electrode is an electrode for use in a secondary battery, wherein the electrode comprises an active material particle and a conductive resin, the active material particle has an inner surface, the conductive resin is positioned so as to contact the inner surface.

An electrode composite according to one aspect of the present disclosure is characterized by that the electrode composite comprises an electrode and an electrolyte layer exchanging an active material with the electrode, wherein the electrode is the electrode of the present disclosure.

A secondary battery according to one aspect of the present disclosure is characterized by that the secondary battery comprises a positive electrode and an electrolyte layer exchanging an active material with the positive electrode, wherein the positive electrode is the electrode of the present disclosure, and the secondary battery comprises a negative electrode exchanging the active material with the electrolyte layer.

A method for manufacturing an electrode according to one aspect of the present disclosure is characterized by that the method comprises: Step 1-1 of preparing an electrode precursor comprising active material particles and having gaps between the active material particles; Step 2-1 of preparing a filling material to be filled into the electrode precursor; Step 3-1 of filling the electrode precursor from an outside to an inside with the filling material; and Step 4-1 of retaining the filling material filled into the inside of the electrode precursor inside the electrode precursor.

Features of the present disclosure will become apparent from the following description of embodiments with reference to the attached drawings. The following description of embodiments is described by way of example.

### BRIEF DESCRIPTION OF THE DRAWINGS

FIG. 1 is an image illustrating a method for manufacturing an electrode precursor.

FIG. 2 is a diagram schematically showing the configuration of a particle arrangement device 1.

FIG. 3 is a diagram schematically showing the configuration of a filling device.

FIGS. 4A to 4C are schematic diagrams of a filling agent transported on a first base material.

FIG. 5 is an enlarged view of the vicinity of the surface of a first base material.

FIGS. 6A and 6B are diagrams schematically showing the configuration of a filling device when brush fibers are used as the carrier material.

FIG. 7 is a diagram schematically showing the configuration of a transfer unit.

FIG. 8 is an enlarged view of the vicinity of the surface of a second base material during a filling process using a second filling device.

FIGS. 9A and 9B are diagrams schematically showing the second base material after first particles P1 and second particles P2 have been transferred.

FIG. 10 is a diagram schematically showing the configuration of a particle arrangement device 2.

FIG. 11 is a diagram schematically showing the configuration of a laminate molding device.

FIG. 12 is a diagram schematically showing the configuration of a sintering processing device.

FIGS. 13A to 13C show SEM images of a laminate and a three-dimensional object at each step of a method for manufacturing an electrode.

FIGS. 14A and 14B show BIB-SEM images of a three-dimensional object according to one embodiment of the present disclosure.

FIGS. 15A and 15B are explanatory drawings illustrating a mechanism related to a three-dimensional object according to one embodiment of the present disclosure.

FIG. 16 is a diagram showing the results of thermogravimetry measurement of a resin base material.

FIGS. 17A and 17B are diagrams showing the results of thermogravimetry and mass spectrometry measurement.

FIG. 18A is a diagram showing an LCO particle after Step 3.

FIGS. 18B to 18E are diagrams showing the results of STEM-EDX of the LCO particle after Step 3.

FIG. 19 is an image illustrating a method for manufacturing an electrode.

FIGS. 20A to 20C are schematic diagrams showing one embodiment of Step 3-1.

FIG. 21 is a diagram showing a charge/discharge curve of a secondary battery.

FIGS. 22A to 22D are diagrams showing an electron microscope image of a positive electrode cross section.

FIGS. 23A to 23E are diagrams showing a low-magnification electron microscope image of a positive electrode cross section.

FIG. 24 is a schematic diagram illustrating features of the present disclosure.

FIGS. 25A to 25C are diagrams showing an electron microscope image of a positive electrode cross section.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. Also, when numerical ranges are described in a stepwise manner, the upper and lower limits of each of the numerical ranges can be arbitrarily combined. In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ. In the case where XX represents a group, a plurality of members may be selected from XX, and the same is true for YY and ZZ.

As a result of the studies conducted by the inventors, it has been found that it is important to arrange a conductive resin (polymer) at an appropriate position relative to the active material particles within the electrode. This makes it easier to suppress a decrease in ion diffusion within the electrode while mitigating the expansion and contraction of each active material particle within the electrode. In the present disclosure, the electrode of the present disclosure is realized by filling an electrode precursor with a polymer and retaining the polymer within the electrode precursor by using the method described below. In the present disclosure, the mitigation of expansion and contraction of each active material particle is conveniently evaluated using an index of the “cycle characteristics” of a prototype battery, and ionic conductivity is conveniently evaluated using an index of the “rate characteristics” of a prototype battery.

The electrode of the present disclosure is for use in a secondary battery. Furthermore, the electrode comprises an active material particle and a conductive resin. As a result of the electrode comprising an active material particle and a conductive resin, ion movement occurs between the electrodes through an electrolyte, making the configuration usable as an electrode.

It is preferable that the active material particle have an inner surface, and that the conductive resin be positioned so as to contact the inner surface of the active material particle. Here, “inner surface” refers to the surface present inside the active material particle.

As a result of the conductive resin being in contact with the inner surface of the active material particles in this way, the flexibility of the conductive resin can mitigate expansion and contraction of the active material particles, while making it easier to suppress a decrease in ion diffusion within the electrode and enabling suppression of a decrease in output characteristics. For example, by performing a sintering processing as in Step 3 described below, the active material particles can be made to have an inner surface within the particles. Furthermore, by filling an electrode precursor with a filling material as in Step 3-1 described below, the conductive resin can be positioned so as to contact the inner surface of the active material particle. Whether the active material particle has an inner surface within the particle can be confirmed using the measurement method described below. Whether the conductive resin is positioned so as to contact the inner surface of the active material particle can be confirmed using the measurement method described below.

The inner surface of the active material particle preferably forms internal pores (hereinafter also referred to as communicating pores) in the active material particle that communicate with the outer surface of the active material particle. By forming such internal pores, it becomes easier to position the filling material so that the filling material contacts the inner surface of the active material particle during Step 3-1 described below.

A method for performing sintering processing, as in Step 3 described hereinbelow, can be exemplified as a method for forming such internal pores. Furthermore, the presence of such internal pores formed by the inner surface of the active material particle can be confirmed using the measurement method described below.

The inner surface of the active material particle is preferably continuous with the outer surface of the active material particle. By having the inner surface continuous with the outer surface, it becomes easier to position the conductive resin so that the conductive resin contacts the inner surface of the active material particle during Step 3-1 described below.

An example of an active material particle with such an internal surface is an active material particle having a core portion and a shell portion.

One method for forming such an internal surface is to perform sintering processing, as in Step 3 described below.

The active material particle preferably has an outer surface, and the conductive resin preferably contacts the outer surface of the active material particles and is arranged to connect the active material particles. Here, the “outer surface” refers to the surface that is present on the outside of the active material particle.

In this way, by arranging the conductive resin so as to contact the outer surfaces of the active material particles, thereby connecting the active material particles, the flexibility of the conductive resin makes it easier to suppress a decrease in ion diffusion within the electrode while mitigating the expansion and contraction of the active material particle. As a result, a decrease in output characteristics can be suppressed.

For example, by filling the electrode precursor with a filling material, as in Step 3-1 described below, the conductive resin can be arranged so as to contact the outer surface of the active material particle and connect the active material particles. The fact that the conductive resin is arranged so as to contact the outer surface of the active material particles and to connect the active material particles can be confirmed using the measurement method described below.

The active material particle preferably has a protrusion portion. The shape of the protrusion portion is not particularly limited, and examples thereof include whisker-like protrusion portions and dendrite-like protrusion portions. In addition, the protrusion portion may protrude from, for example, the outer surface. The presence of such protrusion portion increases the surface area of the active material particle. As a result, when the electrode contains an electrolyte, the contact area with the electrolyte can be increased. The protrusion portion can be formed, for example, by performing sintering processing, such as in Step 3 described below. The presence of protrusion portion on the active material particle can be confirmed by observing the cross section of the electrode, as described below.

The active material particles are not particularly limited and known active material particles can be used. For example, a lithium-containing composite oxide can be used. Specific examples include Li—Co oxide active material particles such as LiCoO₂ (lithium cobalt oxide), LiMO₂ (where Mis an element selected from the group consisting of Ni, Mn, and Co), Li—PO₄ oxide active material particles, lithium vanadium compounds (Li₃V₂(PO₄)₃, LiVOPO₄), and olivine-type phosphate compounds (LiMPO₄ (where M is one or more elements selected from the group consisting of Co, Ni, Mn, Fe, Mg, V, Nb, Ti, Al, and Zr)). Active material particles that do not contain lithium may also be used. Specific examples include metal oxides (MnO₂, V₂O₅, etc.) and fluorides (FeF₃, VF₃, etc.). When using active material particles containing no lithium, lithium-containing metallic lithium or lithium ion-doped negative electrode active material can be arranged as a negative electrode active material and used by starting from a discharge.

Alternatively, negative electrode active material particles such as graphite, silicon, and lithium titanate (LTO) can also be used.

The present inventors have demonstrated that using Li—Co oxide-based active material particles among the above positive electrode active material particles increases the surface area of the positive electrode active material particles and improves the output characteristics of secondary batteries (Japanese Patent Laid-Open No. 2020-198301). Furthermore, Li—PO₄ oxide-based active material particles are highly stable due to the strong covalent bond between P and O and the suppression of oxygen release. For this reason, it is preferable to use Li—Co oxide-based active material particles and Li—PO₄ oxide-based active material particles among the abovementioned positive electrode active material particles.

Commercially available active or separately prepared materials may be used for the active material particles.

Examples of Li—Co oxide active material particles that can be used include CellSeed C-5H (product name, manufactured by Nippon Chemical Industrial Co., Ltd.) (LiCoO₂) and the like. Examples of LiMO₂ (where M is an element selected from the group consisting of Ni, Mn, and Co) include CellSeed NMC (product name, manufactured by Nippon Chemical Industrial Co., Ltd.) (LiNi_{(1-x-y)}MnₓCo_{y}O₂) and the like. Examples of Li—PO₄ oxide active material particles that can be used include Li₃V₂(PO₄)₃ (manufactured by Tokyo Chemical Industry Co., Ltd.) and LiFePO₄ (manufactured by Toshima Manufacturing Co., Ltd.).

When using active material particles with low electronic conductivity, such as Li₃V₂(PO₄)₃ or LiFePO₄, the particle surface may be coated with carbon using a general method.

One type of active material particle may be used, or two or more types may be used in combination.

The electrode preferably contains at least one selected from the group consisting of a conductive resin, a conductive additive, and a supporting electrolyte between the active material particles. It is more preferable that the electrode contain a conductive resin and a supporting electrolyte between the active material particles. This improves lithium ion diffusibility within the electrode and reduces electrode resistance. Furthermore, by reducing the number of isolated active material particles that cannot exchange lithium ions within the electrode, the actual capacity of the battery can be improved.

The fact that the electrode contains at least one selected from the group consisting of a conductive resin, a conductive additive, and a supporting electrolyte between the active material particles can be confirmed by the results of element mapping in the cross-sectional observation described below.

The conductive resin is not particularly limited, and any known resin can be used as long as it is conductive. For example, the conductive resin may be a resin having ionic conductivity. Examples of conductive resins include gel electrolytes and dry polymer electrolytes. From a safety perspective, dry polymer electrolytes that do not contain flammable electrolytic solutions are preferred.

The conductive resin preferably contains at least one of polyurethanes, polyacryls, and polyethers in the main chain structure thereof. Furthermore, polyethers, urethane resins containing polyethers, and acrylic resins containing polyethers are more preferred, with urethane resins containing polyethers being even more preferred. Furthermore, a copolymer of polyethylene glycol and polypropylene glycol is preferred as the polyether.

The conductive resin preferably has an ionic functional group such as a cationic structure in the structure thereof to ensure conductivity. Furthermore, the conductive resin preferably contains an anion. In addition, the conductive resin may be conductive as a result of containing a conductive additive or a supporting electrolyte.

The ionic group is preferably at least one cationic structure selected from the group consisting of cationic nitrogen-containing heterocyclic structures and ammonium cations with a linear or branched structure.

The cationic nitrogen-containing heterocyclic structure is not particularly limited, but may be a four- to eight-membered ring.

Examples of the cationic nitrogen-containing heterocyclic structure include cationic nitrogen-containing aromatic heterocyclic structures such as imidazolium cation, pyridinium cation, pyrazinium cation, pyrimidinium cation, azepinium cation, quinolinium cation, isoquinolinium cation, indolinium cation, quinoxalinium cation, triazolium cation, triazinium cation, and thiazolinium cation; and cationic nitrogen-containing aliphatic heterocyclic structures such as pyrrolidinium cation, pyrrolinium cation, imidazolinium cation, imidazolidinium cation, piperazinium cation, azepanium cation, diazepanium cation such as 1,3-diazepanium cation and 1,4-diazepanium cation, azocanium cation, oxazolinium cation, and morpholinium cation. Among these, the cationic nitrogen-containing aromatic heterocyclic structure is preferably at least one selected from the group consisting of imidazolium cation, pyridinium cation, and pyrazinium cation, with imidazolium cation being more preferred. The cationic nitrogen-containing aliphatic heterocyclic structure is preferably at least one selected from the group consisting of pyrrolidinium cation and piperazinium cation, with pyrrolidinium cation being more preferred.

Ammonium cations having a linear or branched structure include primary ammonium cations, secondary ammonium cations, tertiary ammonium cations, and quaternary ammonium cations, with quaternary ammonium cations being preferred.

The hydrocarbon group of the ammonium cation is not particularly limited, and may, for example, be a hydrocarbon group having 1 to 8 carbon atoms (preferably 1 to 4, more preferably 1 to 2, and even more preferably 1). Furthermore, the linear or branched ammonium cation may have a structure represented by formula (4) below.

The cationic structure may have a freely selected substituent, such as a hydrocarbon group. For example, the cationic structure preferably includes at least one structure selected from the group consisting of structures represented by formulas (1) to (6) below. Each of the structures represented by formulas (1) to (6) is described below.

The structure represented by formula (1) is described below.

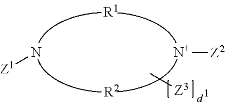

In formula (1), R¹ and R² represent hydrocarbon groups that, together with the nitrogen atoms to which they are bonded, form a five-membered nitrogen-containing aromatic heterocyclic structure. Z¹ to Z³ each independently represent a structure represented by formula (X) below, a hydrogen atom, a hydroxyl group, a hydrocarbon group having 1 to 4 carbon atoms (preferably 1 to 2, more preferably 1), or a hydrocarbon group having 1 to 4 carbon atoms (preferably 1 to 2, more preferably 1) and a hydroxyl group, wherein at least one of Z¹ to Z³ has a structure represented by formula (X) below, and d¹ represents an integer from 0 to 3 (preferably 0 or 1).

As the hydrocarbon group having 1 to 4 carbon atoms, an alkyl group having 1 to 4 carbon atoms is preferred, an alkyl group having 1 to 2 carbon atoms is more preferred, and an alkyl group having 1 carbon atom is even more preferred.

As the hydrocarbon group having 1 to 4 carbon atoms and a hydroxyl group, a hydroxyalkyl group having 1 to 4 carbon atoms is preferred, a hydroxyalkyl group having 1 to 2 carbon atoms is more preferred, and a hydroxyalkyl group having 1 carbon atom is even more preferred. Such hydrocarbon group may also have two or more hydroxyl groups.

The structure represented by formula (1) represents a cation of a five-membered nitrogen-containing aromatic heterocyclic structure having at least one structure represented by the following formula (X) and two nitrogen atoms. The nitrogen-containing aromatic heterocyclic structure in formula (1) is preferably, for example, imidazolium cation.

There are no particular limitations on the method for incorporating the structure represented by formula (1) into the structure of conductive resin. For example, when the conductive resin is a urethane resin, at least one structure represented by formula (1) is incorporated into the structure of the urethane resin by reacting an ionic compound having a structure corresponding to the cation of the five-membered nitrogen-containing aromatic heterocyclic structure represented by formula (1) with an isocyanate compound.

The five-membered nitrogen-containing aromatic heterocyclic structure in formula (1) can be the cationic nitrogen-containing aromatic heterocyclic structure described above in the section relating to cation structure, with imidazolium cation being preferred.

Examples of ionic compounds having a structure corresponding to the cation of the five-membered nitrogen-containing aromatic heterocyclic structure in formula (1) include ionic compounds in which at least one of Z¹ to Z³ in formula (1) has a hydroxyl group and is a linear or branched divalent hydrocarbon. Examples of such ionic compounds include ionic compounds containing imidazolium cation that are listed hereinbelow.

1-Methyl-3-hydroxymethylimidazolium cation, 1-methyl-3-(2-hydroxyethyl)imidazolium cation, 1-methyl-3-(3-hydroxypropyl)imidazolium cation, 1-methyl-3-(4-hydroxybutyl)imidazolium cation, 1-ethyl-3-(2-hydroxyethyl)imidazolium cation, 1-n-butyl-3-(2-hydroxyethyl)imidazolium cation, 1,3-dimethyl-2-(2-hydroxyethyl)imidazolium cation, 1,3-dimethyl-2-(4-hydroxybutyl)imidazolium imidazolium cation, 1,3-dimethyl-4-(2-hydroxyethyl)imidazolium cation;
1,3-bishydroxymethylimidazolium cation, 1,3-bis(2-hydroxyethyl)imidazolium cation, 2-methyl-1,3-bishydroxymethylimidazolium cation, 2-methyl-1,3-bis(2-hydroxyethyl)imidazolium cation, 4-methyl-1,3-bis(2-hydroxyethyl)imidazolium cation, 2-ethyl-1,3-bis(2-hydroxyethyl)imidazolium cation, 4-ethyl-1,3-bis(2-hydroxyethyl)imidazolium cation Imidazolium cation, 2-n-butyl-1,3-bis(2-hydroxyethyl)imidazolium cation, 4-n-butyl-1,3-bis(2-hydroxyethyl)imidazolium cation, 1,3-bis(3-hydroxypropyl)imidazolium cation, 1,3-bis(4-hydroxybutyl)imidazolium cation, 1-methyl-2,3-bis(2-hydroxyethyl)imidazolium cation, 1-methyl-3,4-bis(2-hydroxyethyl)imidazolium cation, 1-methyl-3,5-bis(2-hydroxyethyl)imidazolium cation;
1,2,3-trishydroxymethylimidazolium cation, 1,2,3-tris(2-hydroxyethyl)imidazolium cation, 1,2,3-tris(3-hydroxypropyl)imidazolium cation, 1,2,3-tris(4-hydroxybutyl)imidazolium cation, 1,3,4-trishydroxymethylimidazolium cation, 1,3,4-tris(2-hydroxyethyl)imidazolium cation, 1,3,4-tris(3-hydroxypropyl)imidazolium cation, 1,3,4-tris(4-hydroxybutyl)imidazolium cation; and
derivatives thereof.

The structure represented by formula (2) is described below.

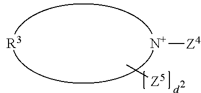

In formula (2), R³ represents a hydrocarbon group that together with the nitrogen atom to which it is bonded forms a nitrogen-containing aromatic heterocyclic structure; Z⁴ and Z⁵ each independently represent a structure represented by formula (X), a hydrogen atom, a hydroxyl group, a hydrocarbon group having 1 to 4 carbon atoms (preferably 1 to 2, more preferably 1), or a hydrocarbon group having 1 to 4 carbon atoms (preferably 1 to 2, more preferably 1) and a hydroxyl group; at least one of Z⁴ and Z⁵ represents a structure represented by formula (X); and d² represents an integer from 0 to 5 (preferably 0 or 1).

As the hydrocarbon group having 1 to 4 carbon atoms, an alkyl group having 1 to 4 carbon atoms is preferred, an alkyl group having 1 to 2 carbon atoms is more preferred, and an alkyl group having 1 carbon atom is even more preferred.

As the hydrocarbon group having 1 to 4 carbon atoms and a hydroxyl group, a hydroxyalkyl group having 1 to 4 carbon atoms is preferred, a hydroxyalkyl group having 1 to 2 carbon atoms is more preferred, and a hydroxyalkyl group having 1 carbon atom is even more preferred. Such hydrocarbon group may also have two or more hydroxyl groups.

The structure represented by formula (2) represents a cation of a nitrogen-containing aromatic heterocyclic structure having at least one structure represented by the following formula (X). The nitrogen-containing aromatic heterocyclic structure in formula (2) may be a five- to eight-membered ring and is preferably a five- or six-membered ring. The nitrogen-containing aromatic heterocyclic structure in formula (2) is preferably, for example, pyridinium cation.

There are no particular limitations on the method for incorporating the structure represented by formula (2) into the structure of conductive resin. For example, when the conductive resin is a urethane resin, at least one structure represented by formula (2) is included in the structure of the urethane resin by reacting an ionic compound having a structure corresponding to the cation of the nitrogen-containing aromatic heterocyclic structure represented by formula (2) with an isocyanate group.

The nitrogen-containing aromatic heterocyclic structure in formula (2) can be the cationic nitrogen-containing aromatic heterocyclic structure described above in the section relating to cation structure, with pyridinium cation being preferred.

Examples of ionic compounds having a structure corresponding to the cation of the nitrogen-containing aromatic heterocyclic structure in formula (2) include ionic compounds in which at least one of Z⁴ and Z⁵ in formula (2) has a hydroxyl group and is a linear or branched divalent hydrocarbon. Examples of such ionic compounds include ionic compounds containing pyridinium cation that are listed hereinbelow.

1-Hydroxymethylpyridinium cation, 1-(2-hydroxyethyl)pyridinium cation, 1-(3-hydroxypropyl)pyridinium cation, 1-(4-hydroxybutyl)pyridinium cation, 2-methyl-1-(2-hydroxyethyl)pyridinium cation, 3-methyl-1-(2-hydroxyethyl)pyridinium cation, 4-methyl-1-(2-hydroxyethyl)pyridinium cation, 3-ethyl-1-(2-hydroxyethyl)pyridinium cation, 3-n-butyl-1-(2-hydroxyethyl)pyridinium cation, 1-methyl-2-hydroxymethylpyridinium cation, 1-methyl-3-hydroxymethylpyridinium cation, 1-methyl-4-hydroxy hydroxymethylpyridinium cation, 1-methyl-2-(2-hydroxyethyl)pyridinium cation, 1-methyl-3-(2-hydroxyethyl)pyridinium cation, 1-methyl-4-(2-hydroxyethyl)pyridinium cation, 1-ethyl-3-(2-hydroxyethyl)pyridinium cation, 1-n-butyl-3-(2-hydroxyethyl)pyridinium cation, 2-methyl-4-n-butyl-1-(2-hydroxyethyl)pyridinium cation;

1,2-bishydroxymethylpyridinium cation, 1,3-bishydroxymethylpyridinium cation, 1,4-bishydroxymethylpyridinium cation, 1,2-bis(2-hydroxyethyl)pyridinium cation, 1,3-bis(2-hydroxyethyl)pyridinium cation, 1,4-bis(2-hydroxyethyl)pyridinium cation, 1,2-bis(3-hydroxypropyl)pyridinium cation, 1,2-bis(3-hydroxypropyl)pyridinium cation, 1,3-bis(3-hydroxypropyl)pyridinium cation, 1,4-bis(3-hydroxypropyl)pyridinium cation, 1,2-bis(4-hydroxybutyl)pyridinium cation, 1,3-bis(4-hydroxybutyl)pyridinium cation, 1,4-bis(4-hydroxybutyl)pyridinium cation, 2-methyl-1,3-bis(2-hydroxyethyl)pyridinium cation, 2-ethyl-1,3-bis(2-hydroxyethyl)pyridinium cation, 5-methyl-1,3-bis(2-hydroxyethyl)pyridinium cation, 5-ethyl-1,3-bis(2-hydroxyethyl)pyridinium cation;

1,2,4-trishydroxymethylpyridinium cation, 1,2,4-tris(2-hydroxyethyl)pyridinium cation, 1,2,4-tris(3-hydroxypropyl)pyridinium cation, 1,2,4-tris(4-hydroxybutyl)pyridinium cation, 1,3,5-trishydroxymethylpyridinium cation, 1,3,5-tris(2-hydroxyethyl)pyridinium cation, 1,3,5-tris(3-hydroxypropyl)pyridinium cation, 1,3,5-tris(4-hydroxybutyl)pyridinium cation; and derivatives thereof.

The structure represented by formula (3) is described below.

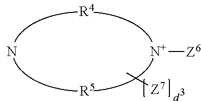

In formula (3), R⁴ and R⁵ represent hydrocarbon groups which, together with the nitrogen atoms to which they are bonded, form a six-membered nitrogen-containing aromatic heterocyclic structure; Z⁶ and Z⁷ each independently represent a structure represented by formula (X) below, a hydrogen atom, a hydroxyl group, a hydrocarbon group having 1 to 4 carbon atoms (preferably 1 to 2, more preferably 1), or a hydrocarbon group having 1 to 4 carbon atoms (preferably 1 to 2, more preferably 1) and a hydroxyl group; at least one of Z⁶ and Z⁷ represents a structure represented by formula (X) below, and d³ represents an integer from 0 to 4 (preferably 0 to 2).

As the hydrocarbon group having 1 to 4 carbon atoms, an alkyl group having 1 to 4 carbon atoms is preferred, an alkyl group having 1 to 2 carbon atoms is more preferred, and an alkyl group having 1 carbon atom is even more preferred.

As the hydrocarbon group having 1 to 4 carbon atoms and a hydroxyl group, a hydroxyalkyl group having 1 to 4 carbon atoms is preferred, a hydroxyalkyl group having 1 to 2 carbon atoms is more preferred, and a hydroxyalkyl group having 1 carbon atom is even more preferred. Such hydrocarbon group may also have two or more hydroxyl groups.

The structure represented by formula (3) represents a cation of a six-membered nitrogen-containing aromatic heterocyclic structure having at least one structure represented by the following formula (X) and two nitrogen atoms. The nitrogen-containing aromatic heterocyclic structure in formula (3) is preferably, for example, pyrazinium cation.

There are no particular limitations on the method for incorporating the structure represented by formula (3) into the structure of conductive resin. For example, when the conductive resin is a urethane resin, at least one structure represented by formula (3) is included in the structure of the urethane resin by reacting an ionic compound having a structure corresponding to the cation of the six-membered nitrogen-containing aromatic heterocyclic structure represented by formula (3) with an isocyanate compound.

The six-membered nitrogen-containing aromatic heterocyclic structure in formula (3) can be the cationic nitrogen-containing aromatic heterocyclic structure described above in the section relating to the cation structure, with pyrimidinium cation and pyrazinium cation being preferred.

Examples of ionic compounds having a structure corresponding to the cation of the six-membered nitrogen-containing aromatic heterocyclic structure in formula (3) include ionic compounds in which at least one of Z⁶ and Z⁷ in formula (3) has a hydroxyl group and is a linear or branched divalent hydrocarbon. Examples of such ionic compounds include ionic compounds containing pyrimidinium cation that are listed hereinbelow.

1,4-Bis(2-hydroxyethyl)pyrimidinium cation, 1,5-bis(3-hydroxybutyl)pyrimidinium cation, 1-(4-hydroxybutyl)-4-(2-hydroxyethyl)pyrimidinium cation, 1,4-bis(2-hydroxyethyl)-2-methylpyrimidinium cation, and derivatives thereof.

The structure represented by formula (4) is described below.

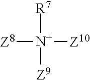

In formula (4), R⁷ represents a hydrogen atom or a hydrocarbon group having 1 to 4 carbon atoms (preferably 1 to 2), and Z⁸ to Z¹⁰ each independently represent a structure represented by the following formula (X), a hydrogen atom, a hydroxyl group, a hydrocarbon group having 1 to 4 carbon atoms (preferably 1 to 2, more preferably 1), or a hydrocarbon group having 1 to 4 carbon atoms (preferably 1 to 2, more preferably 1) and having a hydroxyl group, and at least one of Z⁸ to Z¹⁰ has a structure represented by the following formula (X):

As the hydrocarbon group having 1 to 4 carbon atoms, an alkyl group having 1 to 4 carbon atoms is preferred, an alkyl group having 1 to 2 carbon atoms is more preferred, and an alkyl group having 1 carbon atom is even more preferred.

As the hydrocarbon group having 1 to 4 carbon atoms and a hydroxyl group, a hydroxyalkyl group having 1 to 4 carbon atoms is preferred, a hydroxyalkyl group having 1 to 2 carbon atoms is more preferred, and a hydroxyalkyl group having 1 carbon atom is even more preferred. Such hydrocarbon group may also have two or more hydroxyl groups.

The structure represented by formula (4) represents an ammonium cation having at least one structure represented by formula (X) below.

There are no particular limitations on the method for incorporating the structure represented by formula (4) into the structure of a conductive resin. For example, when the conductive resin is a urethane resin, at least one structure represented by formula (4) is incorporated into the structure of the urethane resin by reacting an ionic compound having a structure corresponding to the ammonium cation represented by formula (4) with an isocyanate compound.

The ammonium cation in formula (4) can be an ammonium cation with a linear or branched structure as described in the section relating to the cation structure above, with quaternary ammonium cation being preferred.

Examples of ionic compounds having a structure corresponding to the cation of the ammonium cation in formula (4) include ionic compounds in which at least one of Z⁸ to Z¹⁰ in formula (4) has a hydroxyl group and is a linear or branched divalent hydrocarbon. Examples of such ionic compounds include ionic compounds containing quaternary ammonium cation that are listed hereinbelow.

2-Hydroxyethyltrimethylammonium cation, 2-hydroxyethyltriethylammonium cation, 4-hydroxybutyltrimethylammonium cation, 4-hydroxybutyl-tri-n-butylammonium cation;
bis(hydroxymethyl)dimethylammonium cation, bis(2-hydroxyethyl)dimethylammonium cation, bis(3-hydroxypropyl)dimethylammonium cation, bis(4-hydroxybutyl)dimethylammonium cation;
tris(hydroxymethyl)methylammonium cation, tris(2-hydroxyethyl)methylammonium cation, tris(3-hydroxypropyl)methylammonium cation, tris(4-hydroxybutyl)methylammonium cation; and derivatives thereof.

The structure represented by formula (5) is described below.

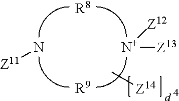

In formula (5), R⁸ and R⁹ represent hydrocarbon groups which, together with the nitrogen atoms to which they are bonded, form a nitrogen-containing aliphatic heterocyclic structure; Z¹¹ to Z¹⁴ each independently represent a structure represented by formula (X) below, a hydrogen atom, a hydroxyl group, a hydrocarbon group having 1 to 4 carbon atoms (preferably 1 to 2, more preferably 1), or a hydrocarbon group having 1 to 4 carbon atoms (preferably 1 to 2, more preferably 1) and a hydroxyl group; at least one of Z¹¹ to Z¹⁴ represents a structure represented by formula (X) below, and d⁴ represents an integer from 0 to 4 (preferably 0 to 2).

As the hydrocarbon group having 1 to 4 carbon atoms, an alkyl group having 1 to 4 carbon atoms is preferred, an alkyl group having 1 to 2 carbon atoms is more preferred, and an alkyl group having 1 carbon atom is even more preferred.

As the hydrocarbon group having 1 to 4 carbon atoms and a hydroxyl group, a hydroxyalkyl group having 1 to 4 carbon atoms is preferred, a hydroxyalkyl group having 1 to 2 carbon atoms is more preferred, and a hydroxyalkyl group having 1 carbon atom is even more preferred. Such hydrocarbon group may also have two or more hydroxyl groups.

The structure represented by formula (5) represents a cation of a nitrogen-containing aliphatic heterocyclic structure having at least one structure represented by the following formula (X) and two nitrogen atoms. The nitrogen-containing aliphatic heterocyclic structure in formula (5) may be a five- to eight-membered ring and is preferably a five- or six-membered ring. The nitrogen-containing aliphatic heterocyclic structure in formula (5) is preferably, for example, piperazinium cation.

There are no particular limitations on the method for incorporating the structure represented by formula (5) into the structure of conductive resin. For example, when the conductive resin is a urethane resin, at least one structure represented by formula (5) is incorporated into the structure of the urethane resin by reacting an ionic compound having a structure corresponding to the cation of the nitrogen-containing aliphatic heterocyclic structure represented by formula (5) with an isocyanate compound.

The nitrogen-containing aliphatic heterocyclic structure in formula (5) can be any of the cationic nitrogen-containing aliphatic heterocyclic structures listed in the section relating to the cation structure above, with piperazinium cation being preferred.

Examples of ionic compounds having a structure corresponding to the cation of the nitrogen-containing aliphatic heterocyclic structure in formula (5) include ionic compounds in which at least one of Z¹¹ to Z¹⁴ in formula (5) has a hydroxyl group and is a linear or branched divalent hydrocarbon. Examples of such ionic compounds include ionic compounds containing piperazinium cation that are listed hereinbelow.

1,1-Bis(2-hydroxyethyl)piperazinium cation, 1,1,4-tris(2-hydroxyethyl)piperazinium cation, 1,4-bis(3-hydroxypropyl)-1-ethylpiperazinium cation, 1,4-bis(2-hydroxyethyl)-1,3-diethylpiperazinium cation, and derivatives thereof.

The structure represented by formula (6) is described below.

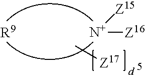

In formula (6), R⁹ represents a hydrocarbon group that, together with the nitrogen atom to which it is bonded, forms a nitrogen-containing aliphatic heterocyclic structure. Z¹⁵ to Z¹⁷ each independently represent a structure represented by formula (X), a hydrogen atom, a hydrocarbon group having 1 to 4 carbon atoms (preferably 1 to 2, more preferably 1), or a hydrocarbon group having 1 to 4 carbon atoms (preferably 1 to 2, more preferably 1) and a hydroxyl group, wherein at least one of Z¹⁵ to Z¹⁷ represents a structure represented by formula (X) below, and d⁵ represents an integer from 0 to 4 (preferably 0 or 1).

As the hydrocarbon group having 1 to 4 carbon atoms, an alkyl group having 1 to 4 carbon atoms is preferred, an alkyl group having 1 to 2 carbon atoms is more preferred, and an alkyl group having 1 carbon atom is even more preferred.

The hydrocarbon group having 1 to 4 carbon atoms and a hydroxyl group is preferably a hydroxyalkyl group having 1 to 4 carbon atoms, more preferably a hydroxyalkyl group having 1 to 2 carbon atoms, and even more preferably a hydroxyalkyl group having 1 carbon atom. Such hydrocarbon group may also have two or more hydroxyl groups.

The structure represented by formula (6) represents a cation of a nitrogen-containing aliphatic heterocyclic structure having at least one structure represented by the following formula (X). The nitrogen-containing aliphatic heterocyclic structure in formula (6) may be a five- to eight-membered ring and is preferably a five- or six-membered ring. The nitrogen-containing aliphatic heterocyclic structure in formula (6) is preferably, for example, a pyrrolidinium cation.

There are no particular limitations on the method for incorporating the structure represented by formula (6) into the structure of conductive resin. For example, when the conductive resin is a urethane resin, at least one structure represented by formula (6) is incorporated into the structure of the urethane resin by reacting an ionic compound having a structure corresponding to the cation of the nitrogen-containing aliphatic heterocyclic structure represented by formula (6) with an isocyanate group.

The nitrogen-containing aliphatic heterocyclic structure in formula (6) can be any of the cationic nitrogen-containing aliphatic heterocyclic structures listed in the section relating to the cation structure above, with pyrrolidinium cation being preferred.

Examples of ionic compounds having a structure corresponding to the cation of the nitrogen-containing aliphatic heterocyclic structure in formula (6) include ionic compounds in which at least one of Z¹⁵ to Z¹⁷ in formula (6) has a hydroxyl group and is a linear or branched divalent hydrocarbon. Examples of such ionic compounds include ionic compounds containing a pyrrolidinium cation that are listed hereinbelow.

1-Methyl-1,2-bis(2-hydroxyethyl) pyrrolidinium cation, 1-ethyl-1,2-bis(2-hydroxyethyl) pyrrolidinium cation, 1-butyl-1,2-bis(2-hydroxyethyl) pyrrolidinium cation, 1-methyl-1,2-bis(4-hydroxybutyl) pyrrolidinium cation, and derivatives thereof.

The structure represented by formula (X) is described below.

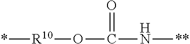

In formula (X), R¹⁰ represents a linear or branched divalent hydrocarbon group, symbol “*” represents a bond to a nitrogen atom in formulas (1) to (6) or a bond to a carbon atom in the nitrogen-containing heterocyclic structure in formulas (1) to (3) and formulas (5) to (6), and symbol “**” represents a bond to a carbon atom in the polymer chain that constitutes the urethane resin having a cationic structure.

R¹⁰ is preferably a linear or branched alkylene group having 1 to 8 carbon atoms (preferably 1 to 4, more preferably 1 to 2). R¹⁰ may also have an optional substituent such as a hydroxyl group.

Where the conductive resin is a urethane resin, the structure represented by formula (X) may be formed by reacting an ionic compound having a structure corresponding to the cation in any of the structures represented by formulas (1) to (6) with an isocyanate compound. The isocyanate compound is preferably a urethane prepolymer obtained by reacting a polyol such as polyether polyol with an isocyanate compound. Polymeric MDI can be used as the isocyanate compound.

Where the cation structure includes the structure represented by formula (1) or the structure represented by formula (2), among the structures represented by formulas (1) to (6), the cation has high stability and a high dissociation rate with the anion which is the counterion. Therefore, when a lithium salt is contained as a supporting electrolyte, such cation is preferred because it is more likely to interact with the anion of the lithium salt, promoting dissociation of the lithium salt and improving ionic conductivity.

When the conductive resin is a urethane resin, the urethane resin preferably has a first urethane bond and a second urethane bond, and further contains a structure represented by formula (7) and a structure represented by formula (8) between the first and second urethane bonds. As a result of the urethane resin having these structures, the crystallinity of the polymer main chain is suppressed even when the molecular weight between crosslinking points is large, making it easier to further suppress the inhibition of ion migration, especially at low temperatures. This is likely to improve ionic conductivity and rate characteristics.

There are no particular limitations on the method for producing such a urethane resin. For example, it can be produced by using a polyethylene glycol-propylene glycol copolymer as a polyol and reacting the polyol with an isocyanate compound. The urethane resin can also be produced by reacting a polyol with a urethane prepolymer obtained by reacting a polyethylene glycol-propylene glycol copolymer with an isocyanate compound, the prepolymer serving as an isocyanate compound.

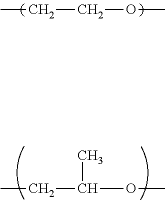

It is even more preferable that the urethane resin contain a structure represented by formula (9) below. When the urethane resin contains the structure represented by formula (9) below, the crystallinity of the polymer main chain is suppressed, making it easier to further suppress the inhibition of lithium ion migration, especially at low temperatures. This is likely to improve ionic conductivity and rate characteristics.

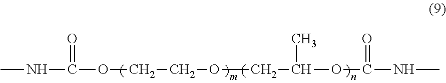

In formula (9), m and n represent the average number of moles added, each independently a natural number of 1 or greater, satisfying the relationship n≤m≤9n.

m is preferably 1 to 110, more preferably 34 to 102.

n is preferably 1 to 55, more preferably 5 to 43.

The structure represented by formula (9) can be obtained, for example, by using a polyether polyol obtained by ring-opening polymerization of ethylene oxide and propylene oxide.

In formula (9), the arrangement of the ethylene oxide structure represented by (—CH₂—CH₂—O—) and the propylene oxide structure represented by (—CH₂—CH(CH₃)—O—) may be block copolymerized or random copolymerized. Random copolymerization is preferred.

To identify the resin structure, known analytical methods such as pyrolysis GC/MS, TF-IR, and NMR can be used, either alone or in combination.

To identify the conductive resin in contact with the inner surface of the active material particle or the conductive resin in contact with the outer surface of the active material particle, known methods capable of mapping the composition, interatomic bonds, crystalline structure, and the like can be used to replace or supplement the aforementioned methods. Examples include viscoelasticity mapping using cross-sectional SPM, elemental mapping using TOF-SIMS, carbon-carbon bond mapping using FT-IR or Raman spectroscopy, and structural mapping of soft textures using a soft X-ray microscope. For soft X-ray microscopes, inspection equipment attached to synchrotron radiation facilities such as SPring-8 can be used.

### Anion Structure

Anions that are preferably to be contained in the conductive resin include, for example, fluoroalkylsulfonylimide anions, fluorosulfonylimide anions, fluoroalkylsulfonate anions, fluorosulfonate anions, fluoroalkylcarboxylate anions, fluoroalkylmethide anions, fluoroborate anions, fluorophosphate anions, dicyanamide anions, thiocyanate anions, bisoxalatoborate anions, perchlorate anions, and derivatives thereof.

Specific examples of fluoroalkylsulfonylimide anions include fluoroalkylsulfonylimide anions having a fluoroalkyl group having from 1 to 6 carbon atoms, such as bis(trifluoromethanesulfonyl)imide anion, bis(pentafluoroethanesulfonyl)imide anion, bis(heptafluoropropanesulfonyl)imide anion, bis(nonafluorobutanesulfonyl)imide anion, bis(dodecafluoropentanesulfonyl)imide anion, and bis(perfluorohexanesulfonyl)imide anion, as well as cyclic fluoroalkylsulfonylimide anions such as N,N-hexafluoropropane-1,3-disulfonylimide.

Specific examples of fluorosulfonylimide anions include bis(fluorosulfonyl)imide anion.

Specific examples of fluoroalkylsulfonate anions include trifluoromethanesulfonate anion, fluoromethanesulfonate anion, perfluoroethanesulfonate anion, perfluoroethanesulfonate anion, perfluoropropanesulfonate anion, perfluorobutanesulfonate anion, perfluorohexanesulfonate anion, and perfluorooctanesulfonate anion.

Specific examples of fluoroalkylcarboxylic acid anions include trifluoroacetate anion, perfluoropropionate anion, perfluorobutyrate anion, perfluorovalerate anion, and perfluorocaproate anion.

Specific examples of fluoroalkylmethide anions include fluorinated alkylsulfonylmethide anions such as tris(trifluoromethanesulfonyl)methide anion, tris(perfluoroethanesulfonyl)methide anion, tris(perfluoropropanesulfonyl)methide anion, tris(perfluorobutanesulfonyl)methide anion, tris(perfluoropentanesulfonyl)methide anion, tris(perfluorohexanesulfonyl)methide anion, and tris(perfluorooctanesulfonyl)methide anion.

Specific examples of fluoroborate anions include tetrafluoroborate anion. Specific examples of fluorophosphate anions include hexafluorophosphate anion.

Among these anions, at least one selected from the group consisting of fluoroalkylsulfonylimide anion, fluorosulfonylimide anion, fluoroborate anion, dicyanamide anion, and thiocyanate anion is particularly preferred because it exhibits less decrease in conductivity in low-temperature environments.

The conductive resin preferably has greater flexibility than the active material particle. When the conductive resin has greater flexibility than the active material particle, the conductive resin is more likely to change shape in response to the expansion and contraction of the active material particle associated with charging and discharging. As a result, it becomes easier to suppress decreases in ionic conductivity and electronic conductivity. Whether the conductive resin has greater flexibility than the active material particles can be confirmed by measuring the Young's modulus using a commercially available device such as a nanoindenter.

The conductive additive is not particularly limited, and examples include graphite such as natural graphite and artificial graphite; carbon black such as acetylene black, Ketjen black, channel black, furnace black, lamp black, and thermal black; carbon fluoride powder; conductive fibers such as carbon fibers, carbon nanotubes, and metal fibers; metal powders such as gold, platinum, silver, and aluminum; conductive whiskers such as zinc oxide; conductive metal oxides such as titanium oxide; and organic conductive materials such as phenylene dielectrics.

The supporting electrolyte is not particularly limited. For example, a conductive resin can be used as an organic electrolyte, and an inorganic electrolyte such as a lithium salt may be included.

Ion-conductive solids commonly used in all-solid-state batteries can also be used. Examples of such solid electrolyte particles include Li—B oxide-based solid electrolyte particles, Li—Yb oxide-based solid electrolyte particles, Nasicon-type solid electrolyte particles (LiAlTi(PO₄)₃, LiAlGe(PO₄)₃, etc.), and Li—P—O-based solid electrolyte particles (Li₃PO₄, LiPON (particles in which some of the O in Li₃PO₄ is replaced with N), etc.). Among the above solid electrolyte particles, Li—B oxide-based solid electrolyte particles and Li—Yb oxide-based solid electrolyte particles can be sintered at relatively low temperatures (700° C. or less), thereby making it possible to suppress a reaction with the positive electrode active material particles during sintering and maintain ionic conductivity. For this reason, among the above solid electrolyte particles, it is preferable to include Li—B oxide-based solid electrolyte particles and Li—Yb oxide-based solid electrolyte particles.

Moreover, it is more preferable that the supporting electrolyte be a lithium salt. Examples of lithium salts include at least one selected from the group consisting of LiClO₄, LiBF₄, LiPF₆, LiAlCl₄, LiSbF₆, LiSCN, LiCF₃SO₃, LiAsF₆, lower aliphatic lithium carboxylates, LiCl, LiBr, LiI, lithium chloroborane, lithium tetraphenylborate, LiN(CF₃SO₃)₃, and LiN(C₂F₅SO₂)₂.

Among these, at least one selected from the group consisting of LiN(CF₃SO₃)₃, LiN(C₂F₅SO₂)₂, and LiClO₄ is preferred. These lithium salts have high chemical stability with respect to lithium-based active materials and are less likely to form an insulating film at the negative electrode interface due to decomposition of the lithium salt. This reduces fluctuations in resistance at the negative electrode interface. One type of lithium salt can be used alone, or two or more types can be used in combination.

The content of the supporting electrolyte is preferably 0.8 parts by mass to 40.0 parts by mass, more preferably 5.0 parts by mass to 40.0 parts by mass, even more preferably 5.0 parts by mass to 15.0 parts by mass, and particularly preferably 5.0 parts by mass to 10.0 parts by mass, per 100 parts by mass of the conductive resin. Supporting electrolyte content within this range ensures good compatibility with the conductive resin, prevents precipitation even at low temperatures, and achieves high ionic conductivity.

The type and content of the supporting electrolyte contained in the conductive resin can be measured using LC-MS or similar methods after solvent extraction.

The solid electrolyte particles may be commercially available or may be prepared separately.

Examples of Li—B oxide solid electrolyte particles that can be used include Li₃BO₃ (manufactured by Toshima Manufacturing Co., Ltd.) and particles in which some of the O in Li₃BO₃ is replaced with C. Furthermore, examples of Li—Yb oxide-based solid electrolyte particles that can be used include Li_{5.9}Yb_{0.81}La_{0.09}Zr_{0.1}(BO₃)₃.

In the case of an electrode containing an inorganic electrolyte between active material particles, it is preferable that a region in which the conductive resin is comprised between the active material particles overlaps a region containing the inorganic electrolyte. This overlap between the region in which the conductive resin is comprised and the region containing an inorganic electrolyte between the active material particles is also referred to as the uneven distribution of the conductive resin and the inorganic electrolyte. It is more preferable that the region in which the conductive resin is contained include the region containing the inorganic electrolyte.

The effect exhibited due to the above-described relationship between the conductive resin and the inorganic electrolyte is that the interfacial resistance between the solid electrolyte particles, which are inorganic electrolyte particles, is reduced. While solid electrolytes (bulk) generally have better ionic conductivity than conductive resins, they are more likely to reduce conductivity due to interfacial resistance between the solid electrolyte particles. By overlapping the conductive resin with the region containing the solid electrolyte particles, it becomes easier to realize a low-resistance electrode without significantly reducing the high ionic conductivity of the solid electrolyte (bulk). Furthermore, the above relationship can be confirmed by the elemental mapping results of cross-sectional observation described hereinbelow.

### Method for Manufacturing Electrode Precursor

An example of a method for manufacturing an electrode precursor is described in detail below with reference to the drawings. The electrode precursor can be made as a positive electrode precursor by using positive electrode active material particles as the active material particles. Furthermore, a negative electrode precursor can be obtained by using negative electrode active material particles as the active material particles.

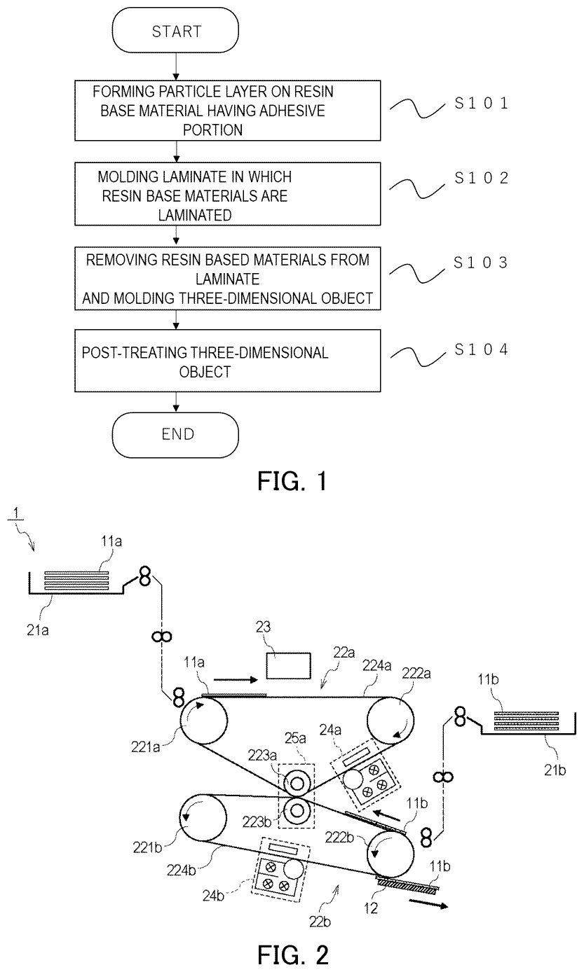

The method for manufacturing an electrode precursor according to the present disclosure preferably includes the following four steps (Step 1, Step 2, Step 3 and Step 4). FIG. 1 is an image illustrating the method for manufacturing an electrode precursor.
(1) Step 1 of forming a particle layer containing active material particles and electrolyte particles on a resin base material provided with an adhesive portion (S101 in FIG. 1).
(2) Step 2 of molding a laminate in which a plurality of resin base materials (hereinafter also referred to as base materials) on which the particle layer has been formed is laminated (S102 in FIG. 1).
(3) Step 3 of removing the resin base materials from the laminate and molding a three-dimensional object containing active material particles and electrolyte particles (S103 in FIG. 1).
(4) Step 4 of post-treating the three-dimensional object (S104 in FIG. 1).

### Step 1

Step 1 is a step of forming a particle layer containing active material particles and electrolyte particles on a resin base material having an adhesive portion. In Step 1, a particle arrangement device is used to place particles on the resin base material to form a particle layer. A particle arrangement device 1 and a particle arrangement device 2 that can be used as the particle arrangement device are described hereinbelow.

### Particle Arrangement Device 1

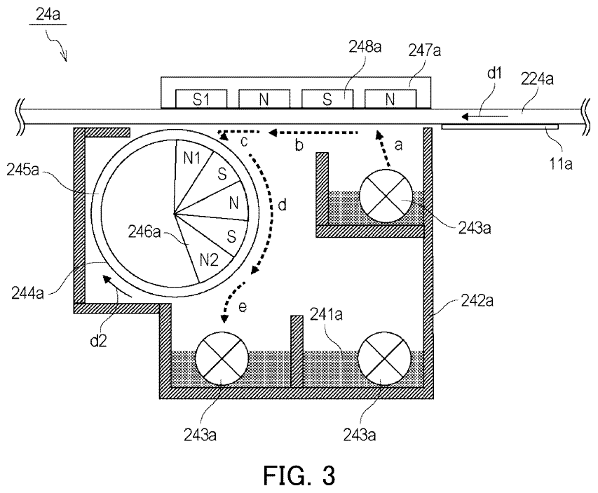

FIG. 2 is a diagram schematically showing the configuration of the particle arrangement device 1. Hereinafter, the term “first particle P1” refers to the active material particle described above, and the term “second particle P2” refers to the electrolyte particle described above.

The particle arrangement device 1 includes a first storage container 21a that stores and supplies a first base material 11a, a first belt device 22a that transports the first base material 11a, and a pattern formation device 23 that forms a protrusion-depression pattern on the first base material 11a. The particle arrangement device 1 also includes a first filling device 24a that places the first particles P1 in the depressions of the protrusion-depression pattern formed on the first base material 11a.

The particle arrangement device 1 also includes a second storage container 21b that stores and supplies a second base material 11b, and a second belt device 22b that transports the second base material 11b. The particle arrangement device 1 has a transfer unit 25a in which rollers 223a of the first belt device 22a and rollers 223b of the second belt device 22b face each other, and the first particles P1 are transferred from the first base material 11a to the second base material 11b in the transfer unit 25a.

Furthermore, the particle arrangement device 1 has a second filling device 24b that places the second particles P2 in a non-transfer portion on the second base material 11b. Devices that are less relevant to explaining the effects of the present invention, such as a peeling and recovery device for peeling and recovering the first base material 11a from the first belt device 22a after transfer, and various cleaning devices, are not shown or described in detail.

In the particle arrangement device 1, the pattern formation device 23, the first filling device 24a, and the transfer unit 25a can be considered to be a first arrangement means for placing the first particles P1 in a pattern on the resin base material, which is the second base material 11b. The second filling device 24b can be considered to be a second arrangement means for placing the second particles P2 in a region on the resin base material, which is the second base material 11b, where the first particles P1 are not placed.

A method for placing particles on the base material 11 using the particle arrangement device 1 will be explained, step by step, hereinbelow following the process flow.

First, the first base material 11a is supplied from the first storage container 21a to the first belt device 22a by a supply means (not shown).

When a UV-curable liquid is applied by the pattern formation device 23 (described below), it is preferable that at least the surface of the first base material 11a be configured of a material that is highly wettable by the UV-curable liquid. The surface of the first base material 11a is preferably smooth.

The first base material 11a can be a resin sheet such as a polyester sheet that has been treated to be hydrophilic or lipophilic to match the UV-curable liquid (water-based or oil-based) to be used. The first base material 11a may be a base material that is individually cut out like cut paper, a continuous base material wound into a roll like roll paper, or a continuous base material that is alternately folded like continuous paper.

The first belt device 22a transports the supplied first base material 11a to the pattern formation position of the pattern formation device 23. The first belt device 22a has drive rollers 221a, 222a, a pressure roller 223a, and a belt-shaped transport member 224a suspended therebetween. The pressure roller 223a rotates driven by the drive rollers.

The transport member 224a is preferably made of a material selected from resins or metals; for example, a polyimide resin belt can be used. The drive rollers 221a, 222a are preferably metal rollers; for example, stainless steel metal rollers can be used. The pressure roller 223a is preferably a soft roller with an elastic layer on the surface thereof; for example, a soft roller with an elastic layer of silicone rubber on the surface of a stainless steel core can be used.

In FIG. 2, the first belt device 22a is used as a transport device for transporting the first base material 11a, but a roller device can also be used instead of the belt device. The same applies to the second belt device 22b, described below.

The pattern formation device 23 forms a fine protrusion-depression pattern on the first base material 11a transported to the pattern formation position. Methods that can be used to form the protrusion-depression pattern include UV imprinting, thermal imprinting, UV inkjet printing, printing, and laser etching.

When the pattern formation device 23 forms the protrusion-depression pattern using UV imprinting, the pattern formation device 23 has a coating means for applying a UV-curable liquid onto the first base material 11a. The UV-curable liquid can be, for example, a UV-curable resin such as UV-curable liquid silicone rubber. The pattern formation device 23 also includes an imprinting unit that imprints a mold having a protrusion-depression pattern on the surface thereof onto the UV-curable liquid on the first base material 11a, and a light source that irradiates the UV-curable liquid with UV light. Typically, UV-curable liquid silicone rubber (PDMS) or resin can be used as the UV-curable liquid, a film mold can be used as the mold, and a UV lamp can be used as the light source.

When the first filling device 24a fills the depressions on the first base material 11a with the first particles P1 using a carrier material S1 carrying the first particles P1, the opening diameter (width) of the depressions in the protrusion-depression pattern on the first base material 11a is preferably larger than the cumulative volume-based 50% particle diameter (median diameter) of the first particles P1. Furthermore, the opening diameter (width) of the depressions is preferably smaller than the average size of the carrier material S1. Here, the opening diameter of the depressions in the protrusion-depression pattern is preferably the opening diameter in the short direction of the depressions, and more preferably the maximum opening diameter in the short direction of the depressions.

The width of the depressions can be adjusted, as appropriate, depending on the particle diameter of the first particles P1 and the carrier material S1. The width of the depressions is not particularly limited, but is preferably 0.2 μm to 30 μm, and more preferably 2 μm to 15 μm.

By setting the opening diameter of the depressions in the protrusion-depression pattern as described above, the first particles P1 can come into contact with the bottoms and side surfaces (typically the bottom surfaces) of the depressions in the protrusion-depression pattern. Meanwhile, the carrier material S1 cannot come into contact with the bottoms or side surfaces of the depressions. This allows the protrusion-depression pattern to capture the first particles P1 that have come into contact with the bottoms or side surfaces of the depressions, while preventing the carrier material S1 from being captured by the protrusion-depression pattern. In other words, it is preferable that the first particles P1 could contact the bottoms and side surfaces of the depressions in the protrusion-depression pattern, while the first carrier material S1 could not contact the bottoms and side surfaces of the depressions in the protrusion-depression pattern.

While the protrusion-depression pattern is formed on the first base material 11a by the pattern formation device 23, a base material with a pre-formed protrusion-depression pattern on the surface thereof may be used as the first base material 11a. Also, the protrusion-depression pattern may be formed directly on the surface of the transport member 224a of the first belt device 22a by the pattern formation device 23, or a transport member with a protrusion-depression pattern on the surface thereof may be used as the transport member 224a. In this case, in consideration of durability, it is preferable to use a metal belt made of stainless steel, aluminum, or the like, and form the protrusion-depression pattern on the surface thereof using a microfabrication technique such as laser etching, wet etching, or dry etching.

The first base material 11a with the protrusion-depression pattern formed on the surface thereof is transported by the first belt device 22a to the filling position of the first filling device 24a.

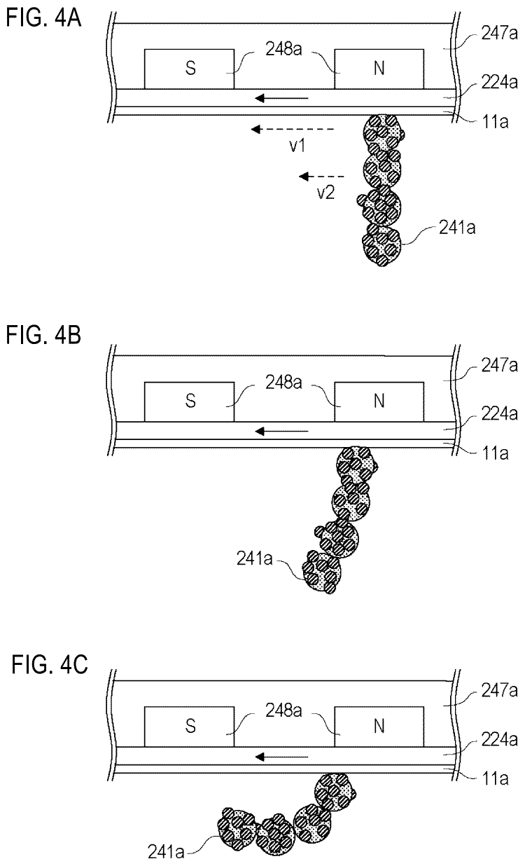

FIG. 3 is a diagram schematically showing the configuration of the filling device. The configuration of the first filling device 24a will be described below, and the same applies to the second filling device 24b.

The first filling device 24a has a filling container 242a that stores a filling agent 241a, a stirring screw member 243a that stirs and transports the filling agent 241a, a recovery member 244a that recovers the filling agent, and a magnetic member 247a.

The filling agent 241a has first particles P1 and a carrier material S1 that carries the first particles P1. The filling agent 241a is a mixture of a plurality of powders, including a powder composed of a plurality of first particles P1 and a powder composed of a plurality of carrier materials S1. The filling agent 241a stored in the filling container 242a is thoroughly mixed when stirred and transported by the stirring screw member 243a. This causes the first particles P1 to be carried on the surface of the carrier material S1. The forces acting between particles being carried include electrostatic forces due to frictional charging etc., van der Waals forces, and liquid bridging forces.

The carrier material S1 is a magnetic particle. The carrier material S1 is preferably a resin particle in which ferrite core particles or magnetic bodies are dispersed, the surface of the resin particle being coated with a resin composition. For example, a magnetic particle such as a standard carrier (Standard Carrier P02, manufactured by the Imaging Society of Japan) can be used. The particle diameter and material of the carrier material S1 are selected, as appropriate, to match the particle diameter and material of the first particles P1. This allows the first particles P1 to be stably carried. Furthermore, even if the first particles P1 have a small particle diameter and are prone to aggregation, stirring and transporting the carrier material S1 helps to break up the aggregates.

The particle diameter of the carrier material S1 can be adjusted, as appropriate, by adjusting the size (area, width, depth) of the depressions. For example, it is preferable that the volume-based cumulative 50% particle diameter (median diameter) be 50 μm to 100 μm.

The recovery member 244a has a roller 245a that can rotate in the direction of arrow d² in the figure, and a magnet 246a that is disposed inside the roller 245a and fixed to the filling container 242a. Furthermore, the magnetic member 247a is disposed opposite the filling container 242a, with the transport member 224a interposed therebetween, and has a magnet 248a inside thereof.

The magnet 246a has a plurality of north and south poles that are alternately arranged in the rotation direction of the recovery member 244a. The magnet 248a has a plurality of north and south poles that are alternately arranged in the transport direction of the transport member 224a. Furthermore, the magnet 246a has a magnetic pole (pole N1 in FIG. 3) of the opposite polarity at the position closest to and facing the most downstream magnetic pole of the magnet 248a (pole S1 in FIG. 3), and a pole N2 of the same polarity as pole N1 is located at the most downstream position.

The magnet 246a and the magnet 248a may be composed of a plurality of magnets, and the type of magnets that make up the magnet 246a and the magnet 248a is not particularly limited. For example, permanent magnets such as rare earth magnets such as ferrite magnets, neodymium magnets, and samarium-cobalt magnets, plastic magnets, etc., or magnetic field generating means such as electromagnets can be used. The magnet 248a may be configured to be movable in the transport direction of the first base material 11a or the opposite direction.

In addition, a regulating member for regulating the filling agent 241a on the first base material 11a, or a recovery member for re-recovering the filling agent 241a that cannot be completely recovered by the recovery member 244a, may be provided upstream or downstream of the recovery member 244a in the transport direction of the transport member 224a. The recovery member for re-recovery may be a member similar to the recovery member 244a, or a recovery member that performs recovery from simple members such as a fixed magnet or regulating member by air blowing.

Next, the process of filling the depressions on the first base material 11a with the first particles P1 using the first filling device 24a will be described using FIGS. 3 to 5.

As the first transport member 224a moves in the direction of solid arrow d¹ in FIG. 3, the first base material 11a, which is being carried and transported by the first transport member 224a, is transported to the filling position of the first filling device 24a.

The filling agent 241a is transported and supplied onto the first base material 11a by the stirring screw member 243a (dotted line a in FIG. 3). At this time, a magnetic field is formed by the magnetic member 247a and the recovery member 244a, and the filling agent 241a containing carrier material S1, which is magnetic particles, forms a plurality of magnetic chains on the first base material 11a due to the magnetic field. As the first base material 11a moves, the filling agent 241a supplied onto the first base material 11a is transported on the first base material 11a while forming the magnetic chains (dotted line b in FIG. 3).

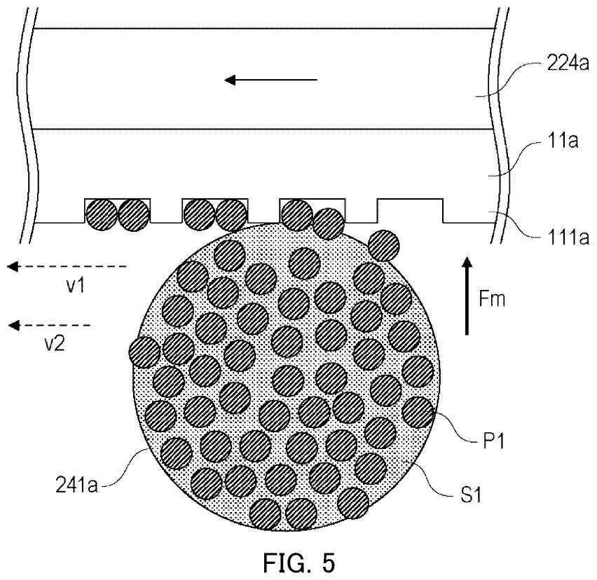

FIGS. 4A, 4B, and 4C are schematic diagrams showing how the filling agent 241a is transported on the first base material 11a. For illustrative purposes, the filling agent 241a other than the filling agent forming a single magnetic chain is not shown. As described above, the filling agent 241a on the first base material 11a forms magnetic chains along the magnetic field lines of the generated magnetic field. As the first base material 11a moves, the magnetic chains change shape as the filling agent 241a is transported, as shown in FIGS. 4A, 4B, and 4C. At this time, because a particularly strong magnetic force acts near the magnet 248a, a transport speed v2 of the filling agent 241a is smaller than a movement speed v1 of the first base material 11a when the filling agent 241a moves away from the magnetic pole, and is larger than the movement speed v1 of the first base material 11a when the filling agent 241a moves toward the magnetic pole. In other words, the filling agent 241a on the first base material 11a has a non-zero relative speed with respect to the first base material 11a.

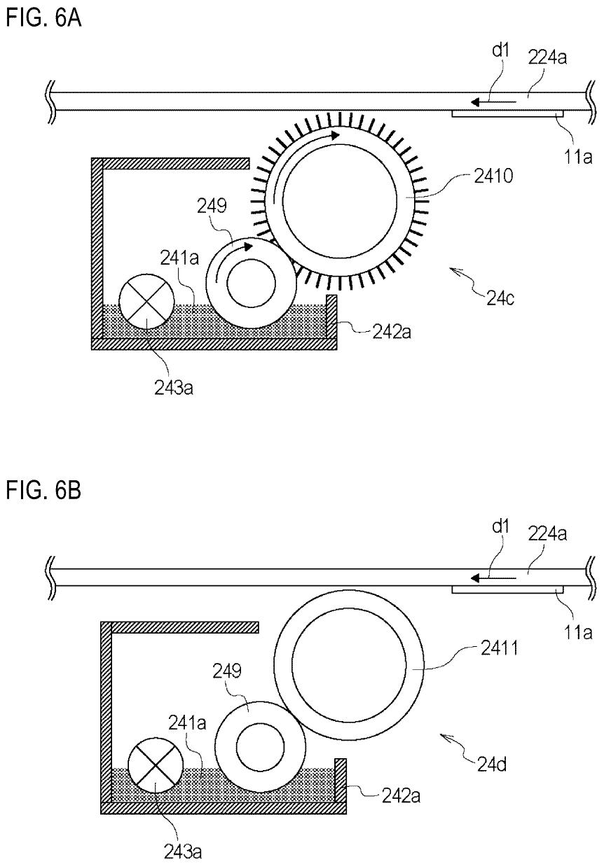

FIG. 5 is an enlarged view of the surface and vicinity of the first base material 11a shown in FIGS. 4A to 4C. Although not shown in FIGS. 4A to 4C, a protrusion-depression pattern 111a is formed on the first base material 11a, as shown in FIG. 5. The protrusion-depression pattern can be formed into any desired pattern, such as a honeycomb pattern or a line pattern.

The filling agent 241a comes into contact with this protrusion-depression pattern 111a and is transported along with the first base material 11a at a non-zero relative speed with respect to the first base material 11a while being subjected to a magnetic force (solid line Fm in the figure) perpendicular to the surface of the first base material 11a. As a result, the first particles P1 carried by the carrier material S1 are transported while being rubbed against the protrusion-depression pattern 111a on the surface of the first base material 11a.

At this time, because the particle diameter of the first particles P1 is smaller than the opening diameter of the depressions in the protrusion-depression pattern 111a, and the particle diameter of the first carrier material S1 is larger than the opening diameter of the depressions, the first particles P1 can come into contact with the bottom surfaces (bottoms) and side surfaces of the depressions in the protrusion-depression pattern 111a, but the carrier material S1 cannot. That is, only the first particles P1 in the filling agent 241a selectively come into contact with the bottom surfaces and side surfaces of the depressions.

The first particles P1 that have come into contact with the depressions are strongly restrained by a physical restraint force created by the structure of the protrusion-depression pattern 111a, by an electrostatic attachment force to the structural materials that constitute the first base material 11a and the protrusion-depression pattern 111a, and by a non-electrostatic attachment force such as an adhesive force, and are detached from the carrier material S1. For the sake of explanation, FIG. 5 shows the first particles P1 carried on the surface of the carrier material S1, but there may also be present particles P1 that are not carried by the carrier material S1 during the stirring, supply, or transport of the filling agent 241a.

Downstream of the magnetic member 247a, as shown in FIG. 3, the recovery member 244a is arranged with a gap between it and the first transport member 224a. As the first base material 11a moves, the filling agent 241a transported near the most downstream magnetic pole (pole S1) of the magnet 248a moves from the first base material 11a to the recovery member 244a under the influence of the magnetic field generated by the magnet 246a, and is recovered (dotted line c in FIG. 3).

As described above, during the transport process (dotted lines a, b, and c in FIG. 3), the depressions of the protrusion-depression pattern 111a on the surface of the first base material 11a come into sufficient contact with a plurality of particles of the filling agent 241a. Therefore, the first particles P1 are selectively and densely arranged in the depressions of the protrusion-depression pattern 111a after the filling agent 241a has been recovered by the recovery member 244a.

While in FIGS. 4A to 4C and 5, all first particles P1 are depicted to have the same particle diameter, in reality there is a particle size distribution. Furthermore, depending on the material, the first particles may aggregate to form secondary particles. Furthermore, the shape may not be spherical as shown. Even in such cases, only particles that can contact the depressions of the protrusion-depression pattern 111a are selectively and densely packed, making it easy to exclude coarse particles and secondary particles that could adversely affect the particle arrangement step.

In this way, the amount of the first particles P1 filled into the depressions of the protrusion-depression pattern 111a can be controlled by the size (area, width, depth) of the protrusion-depression pattern and the particle diameter of the first particles P1. Specifically, the area of the depressions approximately equals the filling area, and the layer thickness of the filled first particles P1 is determined by the depth of the depressions.

The pitch of the protrusions is not particularly limited, but is preferably 1.0 μm to 20 μm, and more preferably 2.0 μm to 15 μm.

The height of the protrusions is not particularly limited, but is preferably 0.1 μm to 20.0 μm, and more preferably 1.0 μm to 10.0 μm.

The area ratio of the depressions (the ratio of depressions to the area of the protrusion-depression pattern) is not particularly limited, but is preferably 50% or more, and more preferably 70% or more.

For example, in order to obtain a thin layer (single layer) that covers 50% of the base material area, the area ratio of the depressions (the area ratio of the depressions to the entire protrusion-depression pattern) can be controlled to 50%, and the depth of the depressions can be controlled to be equal to or less than the particle diameter of the first particles P1. In this case, the opening width of the depressions is set to be greater than the median diameter of the first particles P1 and smaller than the average size (here, the average particle diameter) of the carrier material S1.

The first particles P1 may have a wide particle size distribution (broad particle size distribution), it is preferable that the carrier material S1 have a narrow particle size distribution, and it is more preferable that the carrier material be monodisperse. This makes it easier to prevent the carrier material S1 from coming into contact with the bottoms (or bottom surfaces) or side surfaces of the depressions. Where the carrier material S1 can come into contact with the bottoms or side surfaces of the depressions, the carrier material S1 may also be restrained and filled into the depressions.

Furthermore, the opening width of the depressions in the protrusion-depression pattern 111a is preferably smaller than four times the particle diameter of the first particles P1. By making the opening width smaller than four times the particle diameter of the first particles P1, the probability that the first particle P1 will come into contact with two points, the bottom surface and side surface of the depression in the protrusion-depression pattern 111a, can be increased. In this way, the first particles P1 that come into multi-point contact with the protrusion-depression pattern 111a are strongly restrained by the protrusion-depression pattern 111a, thereby increasing the efficiency of filling the protrusion-depression pattern 111a with the first particles P1.

The same applies to the particle diameter of the second particles P2, described below, and to the size of the depression in the protrusion-depression pattern formed by the first particles P1 on the second base material. Furthermore, where brush fibers are used as the carrier material, the “average particle diameter of the carrier material” in the above description becomes the “average fiber diameter of the carrier material.”

The filling agent 241a recovered by the recovery member 244a is transported by the roller 244a which is the rotating recovery member (dotted line d in FIG. 3). The filling agent 241a transported by the roller 244a falls into the filling container 242a under the effect of the magnetic field generated by two adjacent magnetic poles (N1, N2) of the same polarity, which repel each other, and the influence of gravity (dotted line e in FIG. 3). The recovered particles are then stirred and transported again by the stirring screw member 243a, and the above-described process is repeated thereafter.

The weight ratio of the first particles P1 to the carrier material S1 in the filling agent 241a in the filling container 242a is determined by an inductance sensor that measures magnetic permeability, or a patch density sensor that predicts the weight ratio by measuring the reflection density on the base material or the like, both of which are common in electrophotographic devices. The replenishment of the first particles P1 and/or the carrier material S1 is performed, as needed, by a replenishment means (not shown). This enables stable filling over an extended period of time.

The mass percentage of the first particles P1 in the filling agent 241a is not particularly limited, but is preferably in the range of 5% by mass to 40% by mass, or 10% by mass to 30% by mass.

Note that while the filling device of the type described here uses magnetic particles as a carrier material to form a so-called magnetic brush, by which the depressions are filled with a particulate material, the type of filling device is not limited to this. Brush fibers can also be used as the carrier material. Alternatively, an elastic material, at least the surface of which is configured of an elastic body, can also be used as the carrier material.

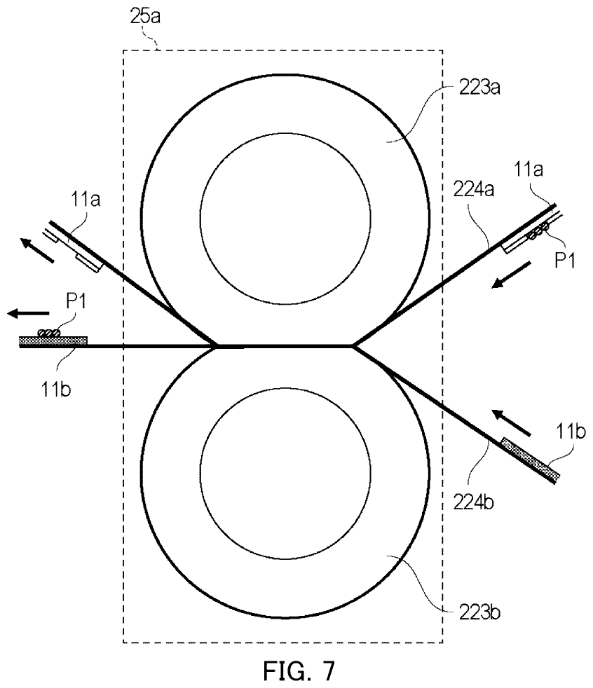

FIG. 6A is a diagram schematically showing the configuration of the filling device 24c when brush fibers are used as the carrier material.

The filling device 24c has a roller 2410 with brush fibers on the surface thereof. The roller 2410 is a so-called brush roller, with brush fibers planted on the surface thereof. The brush fibers of the roller 2410 can be made of nylon, rayon, acrylic resin, vinylon, polyester, vinyl chloride, or other materials. The surface of the fibers may be surface-treated to adjust the charging performance or rigidity.

The filling device 24c has a supply member that supplies the filling agent 241a to the roller 2410. The filling agent 241a contains a powder including first particles P1 and is stored in the filling container 242a. Furthermore, in this example, the filling agent 241a does not contain the carrier material S1, which is magnetic particles. The filling agent 241a is stirred and conveyed by the stirring screw member 243a and supplied to the supply member 249.

The supply member 249 supplies the filling agent 241a to the roller 2410, and the configuration thereof is not particularly limited. The supply member 249 can be, for example, a roller with a surface made of an elastic, porous foam material. Typically, an elastic sponge roller with a foamed skeleton structure and a relatively low-hardness polyurethane foam formed on a core metal can be used. In addition to urethane, various rubber materials such as nitrile rubber, silicone rubber, acrylic rubber, hydrin rubber, and ethylene propylene rubber can be used as the foam material.

The supplied filling agent 241a is filled into the foam material on the surface of the supply member 249 and transported to the supply section that contacts the roller 2410. In the supply section, the filling agent 241a filled into the foam material becomes charged upon contact with the brush fibers of the roller 2410 and is carried by the brush fibers of the roller 2410. Furthermore, the supply member 249 may also have the function of peeling off and refreshing any filling agent 241a remaining on the roller 2410. As the brush fibers move, the filling agent 241a supplied to the roller 2410 comes into contact with the first base material 11a.

At this time, the configuration is such that the first particles P1 in the filling agent 241a can come into contact with the bottom surfaces and side surfaces of the depressions in the protrusion-depression pattern 111a on the surface of the first base material 11a, but the brush fibers cannot. In other words, the fiber diameter of the brush fibers is set larger than the opening width of the depressions in the protrusion-depression pattern 111a. The fiber diameter of the brush fibers can be measured by placing glass on the surface of the roller 2410 and capturing an image of the brush fibers through the glass using an optical microscope. The fiber diameters of approximately 100 brush fibers are measured, the fiber diameter distribution is measured, and the average diameter is calculated.

The movement of the transport member 224a and the rotation of the roller 2410 cause the brush fibers of the roller 2410 to rub against the surface of the first base material 11a. As a result, the first particles carried by the brush fibers are densely arranged in the depressions of the protrusion-depression pattern 111a on the surface of the first base material 11a.

FIG. 6B is a diagram schematically showing the configuration of a filling device 24d when an elastic material is used as the carrier material.

The filling device 24d has a similar configuration to the filling device 24c, but differs in that it uses a roller 2411 having an elastic material instead of the roller 2410 having brush fibers. The roller 2411 is a roller with an elastic layer formed on the surface thereof.

The elastic layer is made of an elastic material, such as a rubber material such as silicone rubber, acrylic rubber, nitrile rubber, urethane rubber, or fluororubber. The surface shape of the elastic layer may be controlled by adding fine particles such as spherical resin particles.

Where the elastic layer has protrusions on the surface thereof, the size of the protrusions of the elastic layer is made larger than the size of the depressions of the protrusion-depression pattern 111a. The size of the protrusions of the elastic layer can be measured using the same method as used to measure the fiber diameter of the brush fibers described above.

As the transport member 224a moves and the roller 2411 rotates, the elastic material on the surface of the roller 2411 rubs against the surface of the first base material 11a. As a result, the first particles carried by the elastic material are densely arranged in the depressions of the protrusion-depression pattern 111a on the surface of the first base material 11a.

By using brush fibers or an elastic material as the carrier material, as shown in FIGS. 6A and 6B, it is no longer necessary to include magnetic particles in the filling agent. This also simplifies the configuration of the filling device. Meanwhile, when magnetic particles are used as the carrier material, as shown in FIG. 3, there is greater freedom in selecting the size and shape of the carrier material than when using brush fibers or an elastic material. Furthermore, magnetic particles allow for greater freedom in the movement of the carrier material on the base material.

For these reasons, when magnetic particles are used as the carrier material, particles such as the first particles P1 can be more efficiently supplied to the base material, allowing for more efficient filling of the depressions on the base material. Furthermore, when a magnetic material is used as the carrier material, even if the carrier material deteriorates during the process, the carrier material can be replenished or replaced without stopping the process.

The method of filling the depressions with particles by rubbing a carrier material that carries the particles can supply a larger number of dispersed particles to the depressions, allowing for more stable and dense filling, compared to filling methods using a regulating member such as a blade. This advantage is more pronounced as the particle diameter of the particles being filled becomes smaller, as the particles tend to aggregate more easily.

The first base material 11a in which the depressions in the protrusion-depression pattern 111a have been filled with the first particles 1 by the first filling device 24a is transported to the transfer unit 25a by the first belt device 22a.

As shown in FIG. 2, the second belt device 22b, like the first belt device 22a, has drive rollers 221b and 222b, a pressure roller 223b, and a belt-shaped transport member 224b suspended between them. The pressure roller 223b is driven to rotate. At the transfer unit 25a, the pressure roller 223a of the first belt device 22a and the pressure roller 223b of the second belt device 22b face each other.

The second base material 11b is supplied from the second storage container 21b to the second belt device 22b and transported in the direction of the arrow in FIG. 2. The supplied second base material 11b is transported in accordance with the timing at which the first base material 11a is transported to the transfer unit 25a. At the transfer unit 25a, the first particles P1 filled in the first base material 11a are transferred to the second base material 11b.

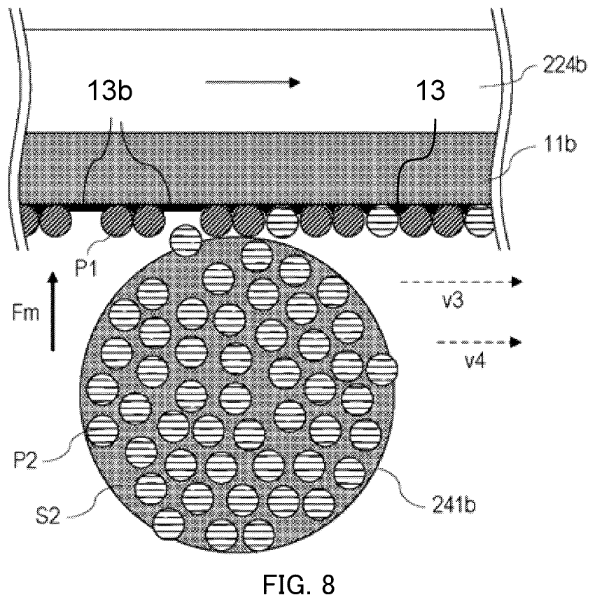

In other words, the first base material 11a can also be referred to as a transfer base material for transferring the first particles P1 to the second base material 11b. The protrusion-depression pattern formed on the surface of the first base material 11a can also be referred to as a protrusion-depression pattern for transfer. This transfer process will be explained below with reference to FIG. 7.

FIG. 7 is a diagram schematically showing the configuration of the transfer unit 25a. The transfer unit 25a is composed of the pressure roller 223a and transport member 224a of the first belt device 22a, and the pressure roller 223b and transport member 224b of the second belt device 22b. As described above, the pressure rollers 223a and 223b rotate by being driven, and the two rollers are in contact with the transport members 224a and 224b interposed therebetween. At least one of the pressure rollers 223a and 223b is a soft roller having an elastic surface layer, and a nip is formed where the two rollers come into contact.

The first base material 11a, filled with the first particles P1 by the first filling device 24a, and the second base material 11b are transported at approximately the same speed by their respective transport members (224a, 224b) and enter the nip formed by the contact of the pressure rollers 223a and 223b. In the nip, the first particles P1 on the first base material 11a come into contact with the second base material 11b and are transferred onto the second base material 11b.

The attachment force of the second base material 11b to the first particles P1 is greater than the attachment force of the first base material 11a to the first particles P1. In other words, the attachment force of the first particles P1 to the second base material 11b is greater than the attachment force of the first particles P1 to the first base material 11a, so that the first particles P1 on the first base material 11a are transferred to the second base material 11b at the nip portion.

The material of the second base material 11b is not particularly limited, and a base material made of the same material as the first base material 11a can be used. Like the first base material 11a, the second base material 11b may be a base material that is individually cut like cut paper, a continuous base material wound into a roll like roll paper, or a continuous base material that is alternately folded like continuous paper.

The second base material 11b is preferably surface-treated to enhance the attachment force so as to transfer the first particles P1 that come into contact therewith. For example, the second base material 11b preferably has an adhesive portion on the surface thereof where an adhesive is applied. For example, the second base material 11b is prepared in a preparation step for preparing a resin base material provided with an adhesive portion. The thickness of the second base material is not particularly limited, but is preferably, for example 1 μm to 10 μm. The thickness of the adhesive portion is also not particularly limited, but is preferably 0.1 μm or more, and more preferably 0.5 μm or more.

Furthermore, the back surface of the second base material 11b (the surface to which the first particles P1 are not transferred) also preferably has an adhesive portion coated with the same adhesive as the front surface, and this surface is further preferably covered with a protective film or the like. This can prevent misalignment between the base materials during lamination, as described below, and firmly fixes the active material particles and electrolyte particles between the base materials by sandwiching the particles between the top and bottom surfaces (in the lamination direction). As a result, particle movement during lamination, storage of the laminate, heat treatment, and pressure application is suppressed, thereby making it possible to mold the desired electrode precursor.

The adhesive is not particularly limited and may be an acrylic adhesive, rubber adhesive, or silicone adhesive, or may be a thermoplastic resin or photocurable resin with an adhesive force changing in response to external disturbances such as heat or light. The particle arrangement device 1 may also have an application means, such as a dispenser or inkjet head, for applying an adhesive to the surface of the second base material 11b during transport.

The type and amount of adhesive applied are adjusted, as appropriate, depending on the shape and material of the protrusion-depression pattern used, and the particle diameter and material of the first particles P1 and second particles P2. However, it is preferable for the adhesive to have a stronger adhesive force than that of the protrusion-depression pattern 111a. The adhesive force can be compared using a common method, such as measuring with a nanoindenter.

At the nip, the first particles P1 are restrained by the attachment force generated between the first particles and the second base material 11b. Where the two transport members 224a and 224b are separated after passing through the nip, the first particles P1 that were on the first base material 11a are transferred to the second base material 11b.

The second base material 11b, to which the first particles P1 have been transferred, is transported by the transport member 224b to the filling position of the second filling device 24b.

The second filling device 24b has the same configuration and function as the first filling device 24a, except that the filling agent 241b having the second particles P2 and the carrier material S2 is contained in the filling container 242a instead of the filling agent 241a having the first particles P1 and the carrier material S1.

The second filling device 24b fills the second particles P2 into the portions on the second base material 11b where the first particles P1 are not arranged. As described above, the first particles P1 are arranged on the second base material 11b that has passed through the transfer unit 25a, but the adhesive portions are exposed in the portions on the second base material where the first particles P1 are not arranged, in other words, depressions are formed. The second filling device 24b fills these depressions (adhesive portions) with the second particles P2 using the same process as used by the first filling device 24a.

In this way, the fillable second particles P2 are selectively filled into voids on the second base material 11b where the first particles P1 are not arranged, thereby improving the coverage of the base material by the particles.

The second particles P2 preferably have a median diameter equal to or less than the opening width of the voids between the first particles P1. In the case explained herein, magnetic particles are used as the carrier material, but brush fibers or elastic materials may also be used as the carrier material, as in the first filling device 24a.

The filling agent 241b includes the second particles P2 and the carrier material S2 that carries the second particles P2. The filling agent 241b is a mixture of a plurality of powders, including a powder composed of a plurality of second particles P2 and a powder composed of a plurality of carrier materials S2. The carrier material S2 may be the same as the carrier material S1 or may be different. This is selected, as appropriate, depending on the particle diameter and material of the second particles P2 and the opening width of the voids described above.

The mass percentage of the second particles P2 in the filling agent 241b is not particularly limited but is preferably in the range of 5% by mass to 40% by mass, or 10% by mass to 30% by mass.

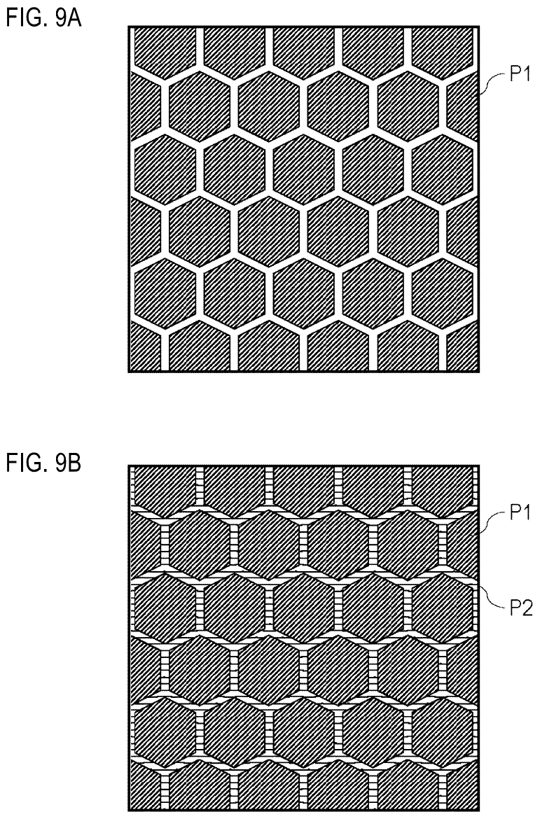

FIG. 8 is an enlarged view of the surface and vicinity of the second base material 11b during the filling process using the second filling device 24b. A protrusion-depression pattern having protrusions formed by the first particles P1 and depressions where no first particles P1 are arranged is formed on the second base material 11b. The adhesive portions 13b are exposed in the depressions on the second base material 11b where the first particles P1 are not arranged. During the filling process using the second filling device 24b, the second particles P2 are arranged on the adhesive portions 13b on the surface of the second base material 11b. After the filling process using the second filling device 24b, the first particles P1 and the second particles P2 are arranged adjacent to each other on the surface of the adhesive portions of the second base material 11b. That is, by arranging the second particles P2 in the portions of the second base material 11b where the first particles P1 are not arranged, the first particles P1 and the second particles P2 can be arranged adjacent to each other. Furthermore, the second particles P2 do not necessarily have to be arranged adjacent to all the first particles P1; the first particles P1 may be adjacent to each other, or the second particles P2 may be adjacent to each other.

The filling agent 241b comes into contact with the protrusion-depression pattern and is transported along with the second base material 11b at a non-zero relative speed with respect to the second base material 11b while being subjected to a magnetic force (solid line Fm in the figure) acting in the direction perpendicular to the surface of the second base material 11b. As a result, the second particles P2 carried by the carrier material S2 are transported while being rubbed against the protrusion-depression pattern on the surface of the second base material 11b.

At this time, the opening width of the depressions in the protrusion-depression pattern is set to a size such that the second particles P2 can come into contact with the depressions but the carrier material S2 cannot. In other words, the opening diameter of the depressions in the protrusion-depression pattern on the second base material 11b is preferably larger than the cumulative 50% particle diameter (median diameter) in the volume-based particle size distribution of the second particles P2. Furthermore, the opening diameter of the depressions is preferably smaller than the average size of the carrier material S2. Here, the opening diameter of the depressions in the protrusion-depression pattern is preferably the opening diameter in the short direction of the depressions, and more preferably the maximum opening diameter in the short direction of the depressions. This allows only the second particles P2 in the filling agent 241b to selectively contact the depressions.

The second particles P2 that have come into contact with the depressions are strongly restrained by a physical restraint force created by the structure of the protrusion-depression pattern, as well as by an electrostatic attachment force and an adhesive force acting between the particles and the structural material (here, the first particles P1) that constitutes the protrusion-depression pattern and the second base material 11b, and are detached from the carrier material S2. For the sake of explanation, FIG. 8 shows the second particles P2 carried on the surface of the carrier material S2. However, during the mixing, supply, or transport of the filling agent 241b, there may be second particles P2 that are not carried on the carrier material S2.

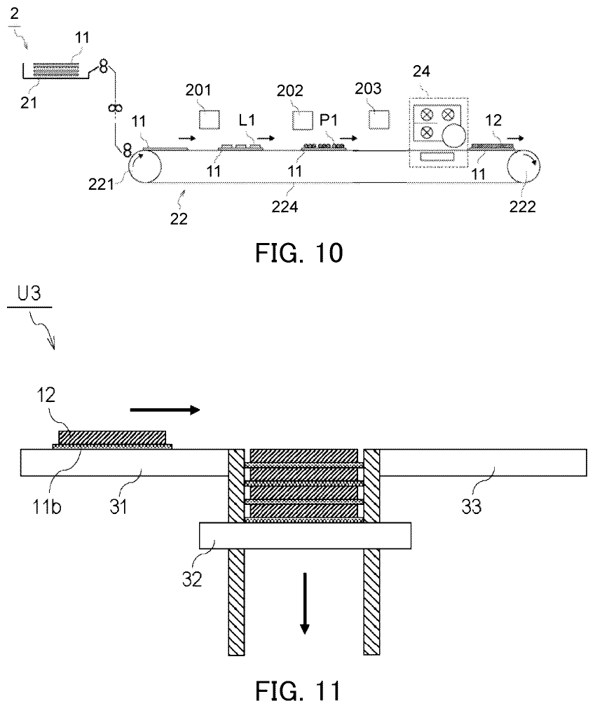

FIG. 9A is a diagram schematically showing the second base material 11b after the first particles P1 have been transferred by the transfer unit 25a. This is a view of the second base material 11b viewed from a direction perpendicular to the base material surface. As shown in FIG. 9A, on the second base material 11b, a honeycomb pattern is formed in which regular hexagonal arrangement regions with the first particles P1 arranged therein are aligned.

The first particles P1 are densely arranged within the regular hexagonal regions. In the remaining portions (white portions in FIG. 9A), the first particles P1 are not arranged and the adhesive portions present on the surface of the second base material 11b are exposed. The regular hexagonal regions in which the first particles P1 are held are referred to as first pattern portions. The honeycomb-patterned regions in which the second particles P2 are held and which correspond to the gaps between to the first pattern portions are referred to as second pattern portions.

FIG. 9B is a diagram schematically showing the second base material 11b after the second particles P2 have been filled by the second filling device 24b, the view of the second base material 11b being taken from a direction perpendicular to the base material surface. As shown in FIG. 9B, the second particles P2 are densely arranged in the regions where the first particles P1 were not arranged and the adhesive portions were exposed. Furthermore, the first particles P1 and the second particles P2 are also densely arranged at the boundaries between the regions where the first particles P1 are arranged and the regions where the second particles P2 are arranged. The particles can also be filled into the small spaces between the first particles P1 using a similar method. In this case, a filling agent containing particles with a particle diameter equivalent to the spaces between the first particles P1 can be used in the same manner as described above to fill the spaces, resulting in the formation of an even denser thin film.

The first particles P1 and the second particles P2 are arranged using single filling devices 24a and 24b, respectively. However, a plurality of filling devices may also be used. This can improve density. Furthermore, the number of types of particles is not limited to the first particles P1 and second particles P2. By adding a filling device, third particles other than the first and second particles can also be arranged.

### Particle Arrangement Device 2

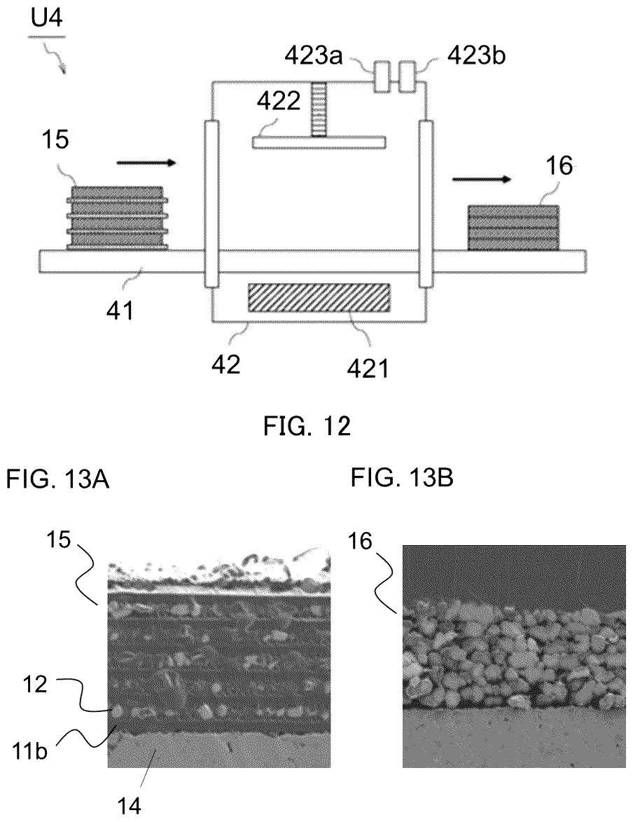

FIG. 10 is a diagram schematically showing the configuration of the particle arrangement device 2. The particle arrangement device 2 is a device that forms the particle layer 12 on the base material 11 and includes a storage container 21 that stores and supplies the base material 11, and a belt device 22 that transports the base material 11. The particle arrangement device 2 may also include a liquid application device 201 that arranges a liquid on the base material 11 to provide adhesive portions. In this case, in order to densely arrange the particles on the base material 11, it is preferable to arrange the liquid in a pattern on the base material 11.

The liquid application device 201 can be a device that ejects liquid using an inkjet method or a device that applies liquid, but a plate-based method such as a flexographic printing plate can also be used. Among these, it is preferable to use a device that ejects liquid using an inkjet method as the liquid application device.

The device that ejects liquid using an inkjet method can be a device that uses a variety of ejection methods, such as thermal, piezo, electrostatic, and continuous types.

The liquid applied by the liquid application device 201 may be water-based or oil-based, as long as it contains a material to which the first particles P1 can adhere. The liquid can be selected, as appropriate, e.g., by selecting a material that does not react with the first particles P1. The liquid application device 201 may also form a pattern L1 using a plurality of types of liquid. For example, the liquid application device 201 may apply two types of liquid that react with the base material 11 to increase adhesion. Examples of materials to which the first particles P1 can adhere include resins such as acrylic resin.

A powder application device 202 applies powder containing the first particles P1 to the base material 11 on which the liquid has been arranged in a pattern. As a result, the first particles P1 are fixed by the material present on the base material 11, and the particles P1 are fixed in a pattern corresponding to the pattern L1.

A powder application means using the powder application device 202 can apply powder by spraying or sprinkling the powder toward the base material 11. The powder application device 202 may further include a means for removing the first particles P1 that are not fixed to the base material 11 by vibrations, centrifugation, air blowing, suction, or the like.

The particle arrangement device 2 may further include a drying device that evaporates at least a portion of the liquid applied by the liquid application device 201 to control the amount of material on the base material 11, the thickness of the pattern L1, and the like. This drying device may be provided downstream of the liquid application device 201 and upstream of the powder application device 202. The material on the base material after drying may be a liquid, a liquid containing solids, or solids only.

After the first particles P1 have been fixed and arranged on the base material 11, a liquid application device 203 applies a liquid to form adhesive portions in at least the regions where the first particles P1 were not arranged. The liquid application device 203 has the same function as the liquid application device 201. After the liquid has been applied to the base material 11 by the liquid application device 203, the second particles P2 are arranged on the base material 11 using the second filling device 24. As a result, a dense particle layer 12 is formed on the base material 11.

Furthermore, like the particle arrangement device 1, the particle arrangement device 2 may have a transfer unit. In this case, the transfer unit is provided downstream of the powder application device 202. The first particles P1 are transferred from the base material 11 to another base material having an adhesive portion. In the base material to which the first particles P1 have been transferred, the second particles P2 can be arranged using the second filling device 24 in the regions where the first particles P1 are not arranged and the adhesive portions are exposed. This makes it possible to densely arrange the first particles P1 and the second particles P2 on the adhesive portions of the resin base material.

In the particle arrangement devices 1 and 2, the coverage of the resin base material with the first particles P1 and the second particles P2 is preferably 60% or more, more preferably 70% or more, and even more preferably 80% or more. The coverage of the resin base material with the first particles P1 and the second particles P2 can be measured by photographing the region where the particle layer is formed using an optical microscope from a direction perpendicular to the base material and calculating the area ratio of the first particles P1 and the second particles P2 within that region using image processing software.

Using the above-mentioned particle arrangement device 1 or particle arrangement device 2, in Step 1 (S101 in FIG. 1) of FIG. 1, the first particles P1 and the second particles P2 are arranged on the adhesive portions of the resin base material.

### Step 2

Step 2 is a step of molding a laminate in which a plurality of resin base materials (hereinafter also referred to as base materials) on which particle layer has been formed is laminated. The number of layers in the laminate is not particularly limited and is determined according to the desired electrode capacity. Furthermore, the laminate is preferably formed on a current collector, such as a positive electrode current collector serving as a base. That is, the laminate preferably includes a base. Known current collectors, such as Al foil, SUS foil, platinum foil, or gold foil, can be used as the current collector. An electrolyte may also be used as the base.

In this case, the electrolyte may be a separately prepared solid electrolyte sheet or an electrolyte base material consisting of electrolyte particles on a similar base material. A solid electrolyte may also be used as the electrolyte. Furthermore, when the electrode is a positive electrode, the solid electrolyte sheet or electrolyte base material may have a negative electrode or negative electrode base material formed on the side opposite to the positive electrode base material.

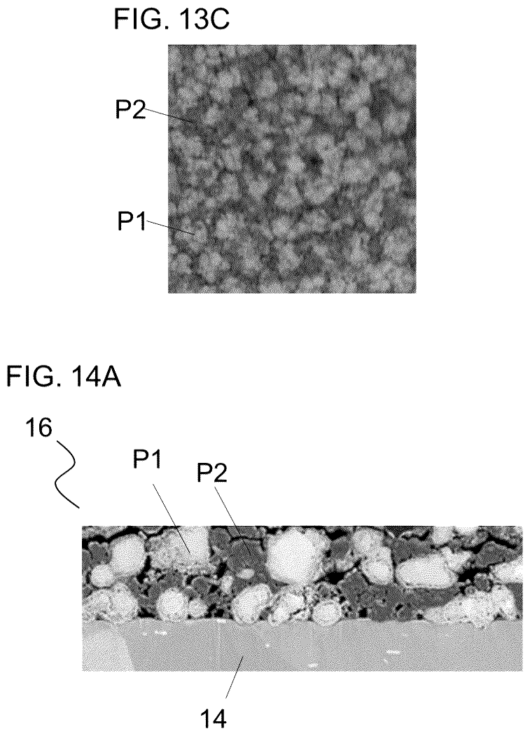

FIG. 11 is a diagram schematically showing the configuration of a laminate molding apparatus U3. The laminate molding apparatus U3 includes a transport device 31 that transports the base material 11 on which the particle layer 12 has been formed, and a stage 32 that can be moved forward and backward in the vertical direction by an actuator (not shown).

The transport device 31 receives the base material 11 having the particle layer 12 formed thereon using the particle arrangement device and transports the base material to the stage 32. Examples of the transport device 31 capable of transporting the base material 11 include a belt conveyor, rollers, and a robot arm.

When the transport device 31 transports the base material 11 to the stage 32, the stage 32 moves vertically by an amount equal to the thickness of the base material 11 and particle layer 12. By repeating the transport by the transport device 31 and the movement of the stage 32, a plurality of base materials 11, each with a particle layer 12 formed thereon, are laminated to mold the laminate 15.

In this case, it is preferable that the backside of the base material 11 on which the particle layer 12 has been formed has an adhesive portion. This adhesive portion causes the base materials to adhere to each other, increasing the strength of the laminate and preventing misalignment between the base materials even in Step 2 and subsequent steps. Furthermore, the particle layer 12 between the base materials is sandwiched between the upper and lower adhesive portions, thereby preventing misalignment during processing and storage of the laminate. The adhesive portion may be coated using a coating device (not shown) before lamination, or a pre-coated base material may be used, and a protective film covering the coated surface may be peeled off before lamination.

It is preferable to have a static elimination step in which the base material is subjected to static elimination immediately before the laminate 15 is molded. The particle layer 12, which has been formed using a particle arrangement device, and the base material 11 are easily charged, and electrostatic repulsion occurs between the base materials during lamination. As a result, when laminating in Step 2, the base materials are likely to peel off or voids may form between the base materials. In the static elimination step, it is preferable to perform contactless static elimination using an electrostatic elimination blower or the like.

In addition, it is preferable to have a degassing step in which the laminate is degassed after the laminate 15 has been molded to reduce voids between the base materials. In the degassing step, it is preferable to degas using a vacuum packaging machine or the like.

### Step 3

Step 3 is a step of removing the resin base materials from the laminate and molding a three-dimensional object containing active material particles and electrolyte particles. Preferably, Step 3 is a step of sintering the laminate to remove the resin base materials from the laminate. This allows the active material particles to have inner and outer surfaces. In other words, Step 3 can be considered to be a step of forming inner surfaces on the active material particles and also can be considered to be a step of forming outer surfaces on the active material particles.

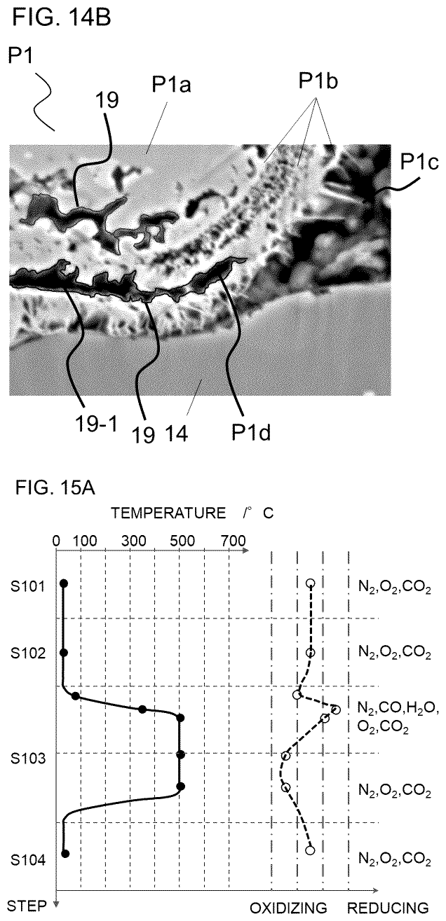

FIG. 12 is a diagram schematically showing the configuration of a sintering processing device U4. The sintering processing device U4 includes a transport device 41 that transports the laminate 15 and a heating furnace 42 that heats the laminate 15.

The transport device 41 receives the laminate 15 from the laminate molding device and transports the laminate to the heating furnace 42. Similar to the transport device 31, the transport device 41 is preferably a device capable of transporting the laminate 15. Examples of devices capable of transporting the laminate 15 include a belt conveyor, rollers, and a robot arm.

The heating furnace 42 is a furnace for heating the laminate 15. The heating furnace 42 includes a heating means 421, a pressurizing means 422, and an atmosphere adjusting means 423 (423a and 423b). A firing furnace used for firing ceramics or the like can be used as the heating furnace 42. The pressurizing means 422 applies pressure to the laminate 15 being heated in the heating furnace 42, and to the laminate 15 before and after heating.

In the pressurizing means 422, a pressurizing section that pressurizes the laminate 15 is preferably formed of a porous material that allows gas to easily pass therethrough. The atmosphere adjusting means 423 includes an atmosphere gas supply means 423a and a pressure reducing means 423b, and adjusts the atmosphere gas within the processing space of the heating furnace 42.

The atmosphere gas can be an oxidizing atmosphere (O₂), an inert atmosphere (Ar, N₂, etc.), or a reducing atmosphere (Ar—H₂), but sintering can also be performed in air.

When sintering the laminate, it is preferable to heat the laminate at a temperature equal to or higher than the thermal decomposition temperature of the base material 11 in the laminate 15, and preferably at a temperature lower than the thermal decomposition temperature of each particle layer in the laminate 15. The temperature to which the laminate is heated is preferably from 200° C. to 1000° C., more preferably from 400° C. to 800° C., particularly preferably from 450° C. to 800° C., and especially preferably from 450° C. to 650° C. The sintering temperature is preferably maintained for 30 min or longer, more preferably 1 h or longer. There is no upper limit, but it may be, for example, 3 h or shorter, or 2 h or shorter. For example, it is preferable to maintain the sintering temperature for 30 min to 3 h, or 1 h to 2 h.

The thermal decomposition temperature is the temperature at which the material begins to lose weight when the temperature is gradually increased in the heating atmosphere in the sintering processing device. Therefore, by heating the laminate at a temperature equal to or higher than the thermal decomposition temperature of the base material 11, the base material 11 in the laminate can be decomposed to reduce its weight, and the base material 11 can be removed from the laminate.

The heating temperature is preferably a temperature equal to or higher than the thermal decomposition temperature of the base material 11, but it is preferable to heat at a temperature even higher than the thermal decomposition temperature. Specifically, when thermogravimetric analysis is performed by raising the temperature from room temperature (25° C.) at a rate of 5° C./min in a heating atmosphere (typically air) when performing heating in a sintering processing device, it is preferable to heat at a temperature equal to or higher than the temperature at which the base material loses 70% of its initial weight. Specifically, for example, 385° C. or higher is preferable.

Furthermore, when similar thermogravimetric analysis is performed, it is more preferable to heat at a temperature equal to or higher than the temperature at which the base material loses 50% of its initial weight, and even more preferable to heat at a temperature equal to or higher than the temperature at which the base material loses 20% of its initial weight. Specifically, for example, 400° C. or higher is preferable, and 450° C. or higher is more preferable. This can shorten the time required to remove the base material 11 and can increase the removal rate of the base material 11.

As described above, when the sintering processing device removes the base material 11 by heating, it is preferable that the active material particles and solid electrolyte particles have a higher thermal decomposition temperature than the base material 11. In general, inorganic materials tend to have higher thermal decomposition temperatures than organic materials, so it is preferable that the active material particles and solid electrolyte particles be inorganic materials, and the base material 11 be made of an organic material such as resin. Furthermore, when the sintering processing device removes the base material 11 by heating, it is preferable that the active material particles be made of a material with a softening temperature higher than the thermal decomposition temperature of the base material 11.

The sintering processing device preferably removes 90% by weight or more of the resin base material in the laminate 15 by heating, more preferably 95% by weight or more, and even more preferably 97% by weight or more. At this time, it is preferable that the resin base material be burned or gasified and released to the outside as a gas. When the resin base material gasified by thermal decomposition is released to the outside of the laminate as a gas, it may push up the particle layer formed on the resin base material, distorting its shape.

For this reason, it is preferable to decrease the thickness of the resin base material to reduce the impact on the particle layer.

Specifically, the thickness (μm) of the resin base material is preferably no more than 10 times the thickness of the particle layer on the resin base material, more preferably no more than 5 times, and even more preferably no more than 2 times. Here, the thickness of the particle layer refers to the difference between the maximum and minimum z values in a region (x, y, z) where each particle arranged on the resin base material is present, where the resin base material surface is (x, y) and the lamination direction of the resin base material is (z).

The thickness of the particle layer on the resin base material is calculated by performing SEM observations of the cross section of the laminate 15 using a BIB-SEM, determining the particle presence region (x, z), where x is the resin base material surface and z is the lamination direction of the resin base material, by using image processing software, and calculating the difference between the maximum and minimum z values. Here, the BIB-SEM imaging conditions, required image region, and image processing method are the same as those described below.

The thickness of the resin base material, like the particle diameter of the active material particles, can be determined using a BIB-SEM, or it can be measured using a digital thickness gauge. Furthermore, in SEM observations using a BIB-SEM, elemental composition analysis using EDS can be used for identifying the active material particles, solid electrolyte particles, base material, and adhesive portions.

To observe the cross section of an electrode, a cross section is processed using a broad ion beam (BIB) of Ar, and the cross section is then two-dimensionally imaged using a scanning electron microscope. Hereafter, this method of observing two-dimensional images is referred to as BIB-SEM. Details of the measurement method are described below.

### BIB-SEM Imaging Method

A cross section of electrode is imaged using a BIB-SEM.

The following explains the imaging conditions for BIB-SEM.

Where the electrode is included in a battery, the battery is disassembled and a sample containing the electrode is taken out. For example, in the case of a laminated battery, the laminated structure is opened and the laminate containing the electrodes is taken out. To reduce the load of the cross section processing described below, the other current collector and electrode not required for imaging are separated from the laminate, and an electrode-containing sample is taken out. The electrode can be identified as the region between the electrolyte layer and the current collector.

The sample is cut using a wire saw (DWS3400, wire diameter 170 μm, diamond diameter 30 μm) to obtain a cross section along the lamination direction. The cut surface is then cross-sectional processed using a broad ion beam (SM-09010 Cross Section Polisher, manufactured by JEOL Ltd.) of Ar. The cross-sectional processing conditions are a voltage of 6 kV and a current of 150 to 200 mA. A cross section of the electrode sample in the lamination direction is obtained as a BIB-SEM image, and the cross-sectional observation is then performed. Instead of a broad ion beam (BIB), a fine ion beam (FIB) can also be used in which the ion particle intensity in the beam and beam diameter are varied.

The cross section is imaged using an electron microscope (ULTRA55) under the following conditions:
Detector: ESB (backscattered electron image)
Observation conditions: accelerating voltage 3 kV
Magnification: 1000×
Filter: ESB filter with 1500 V bias applied

Next, an SEM-EDX (XFlash Detector 630M, manufactured by Bruker Co., Ltd.) is used to analyze the elements and composition of each electrode particle and conductive resin, and to identify the active material particles, electrolyte particles, and conductive resin.

The active material particles, electrolyte particles, and conductive resin are identified using the method described above. The electrode is analyzed using X-ray diffraction (XRD) and other techniques to identify the substances constituting the electrode. The specific elements contained in the active material particles, electrolyte particles, and conductive resin are then detected and identified with SEM-EDX by using the method described above. In addition to the X-ray diffraction described above, the substances constituting the electrode can also be identified using electron energy loss spectroscopy (EELS) in a TEM. Raman spectroscopy and TOF-SIMS can also be used. The substances constituting the electrode may be identified by a combination of the above analytical methods.

The thickness of the resin base material is preferably from 1 μm to 1 mm. The thickness of the particle layer is preferably from 0.1 μm to 100 μm.

By using a base material formed from an organic material such as resin as the base material, the removal of the base material by heating can be facilitated. Materials that can be used to constitute the base material include polyesters such as polyethylene (PE), polypropylene (PP), and polyethylene terephthalate (PET), and polyamides such as nylon. Of these, PET is preferred due to low decomposition temperature thereof, as well as low toxicity of the gas generated during thermal decomposition.

In the sintering processing device, the released gas is preferably exhausted to the outside of the heating furnace 42 using the pressure reducing means 423b. By creating an oxidizing atmosphere inside the heating furnace 42 using the atmosphere gas supply means 423a, i.e., an atmosphere containing oxygen gas such as air, the resin base material can be burned and removed. Meanwhile, depending on the active material particles and electrolyte particles used, sintering in an oxidizing atmosphere may cause decomposition or compositional changes. In such cases, sintering in an inert atmosphere (Ar, N₂, etc.) or a reducing atmosphere (Ar—H₂) is preferable.

As mentioned above, when the resin base material is gasified by thermal decomposition and released from the laminate 15 as gas, the individual particle layers in the laminate 15 may be pushed up and their shape may change. Therefore, when heating in the heating furnace 42, the laminate 15 may be pressurized using the pressurizing means 422 before or during heating.

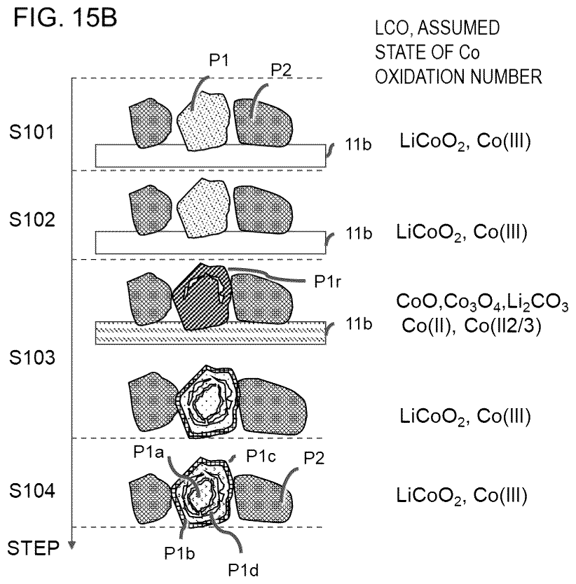

FIG. 13A is a BIB-SEM image of the cross section of the laminate after Step 2. This image corresponds to a cross section of laminate 15 in which six lamination units, each including the particle layer 12 and the second base material 11b, are laminated on the resin base material 14 so that the particle layers 12 and the second base material 11b are alternated. FIG. 13B is a BIB-SEM image of the three-dimensional object 16 after Step 3. The resin base material has been removed from the laminate 15, resulting in the three-dimensional object 16 consisting of six particle layers. FIG. 13C is an SEM image of the top of the three-dimensional object 16. The first particles P1 and second particles P2 that have been periodically arranged on second base material 11b in Step 1 remain in place even after Step 2.

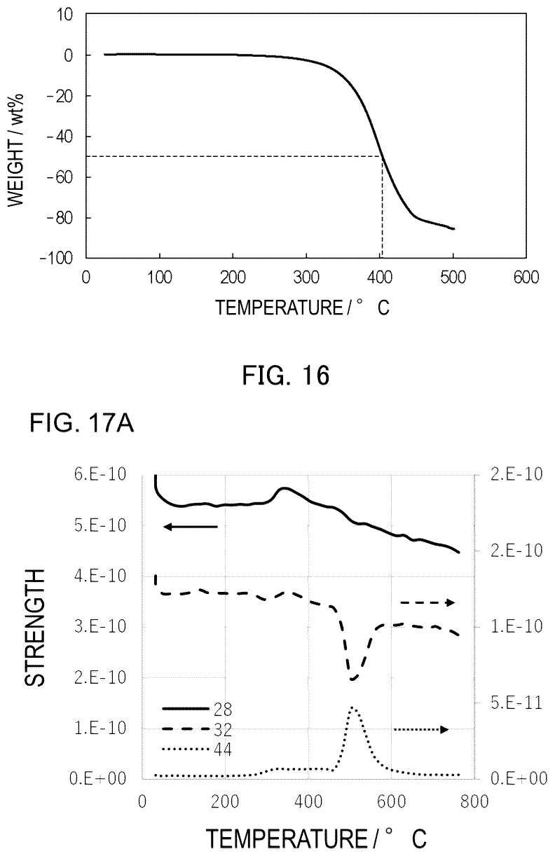

FIG. 14A is a BIB-SEM image of the three-dimensional object 16 according to one embodiment (Example 1) of the present disclosure. FIG. 14B is an enlarged image of FIG. 14A.

The three-dimensional object 16 is molded by the manufacturing method of the present disclosure using positive electrode active material particles LiCoO₂ (hereinafter referred to as LCO) as the first particles P1 and electrolyte particles Li₃BO₃ (hereinafter referred to as LBO) as the second particles P2. In the present embodiment, as shown in FIGS. 14A and 14B, the LCO particle (first particle P1) has a core portion Pla, a shell portion P1b, and a radially protruding protrusion Plc on the surface of the shell portion. A gap P1d is present between the core portion and the shell portion. In FIG. 14B, P1d is an internal hole within the active material particle that communicates with the outer surface of the active material particle and can also be referred to as a communicating hole 19-1. The LCO particle also has an inner surface 19 as indicated by the solid line.

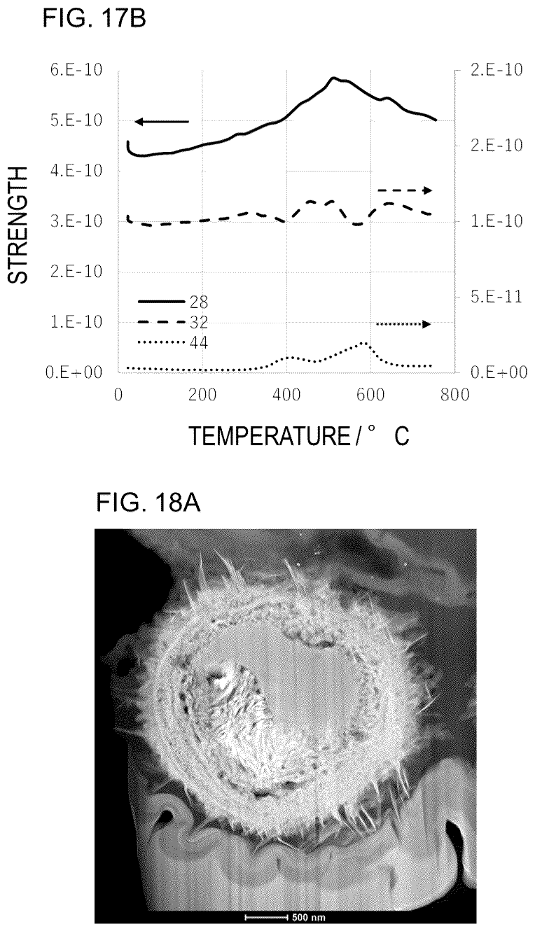

The presumed mechanism by which the three-dimensional object 16 has the above-described configuration in the present embodiment will be explained using FIGS. 15A to 18E.

FIG. 15A shows an example of a temperature profile as well as a profile showing the redox behavior depending on the atmosphere for each step (S101 to S104) of the method for manufacturing an electrode precursor of the present disclosure. FIG. 15B is a schematic diagram showing the changes in LCO particles in the profile shown in FIG. 15A. In Step 1 (S101) and Step 2 (S102), the LCO particles on the resin base material do not changed due to the room temperature and air (or an inert atmosphere). Meanwhile, in Step 3 (S103), the base material is heated in a sintering treatment device (air). Here, the temperature exceeds the melting point of the resin base material and the base material begins to lose weight once it is sufficiently heated.

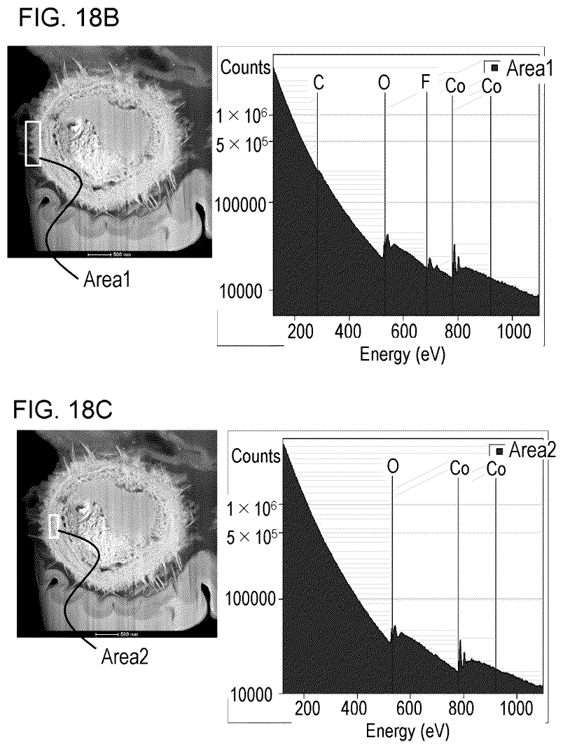

FIG. 16 shows the results of thermogravimetry (TG) of the resin base material. Weight loss begins at around 300° C., which is above the melting point of the resin base material (approximately 260° C.).

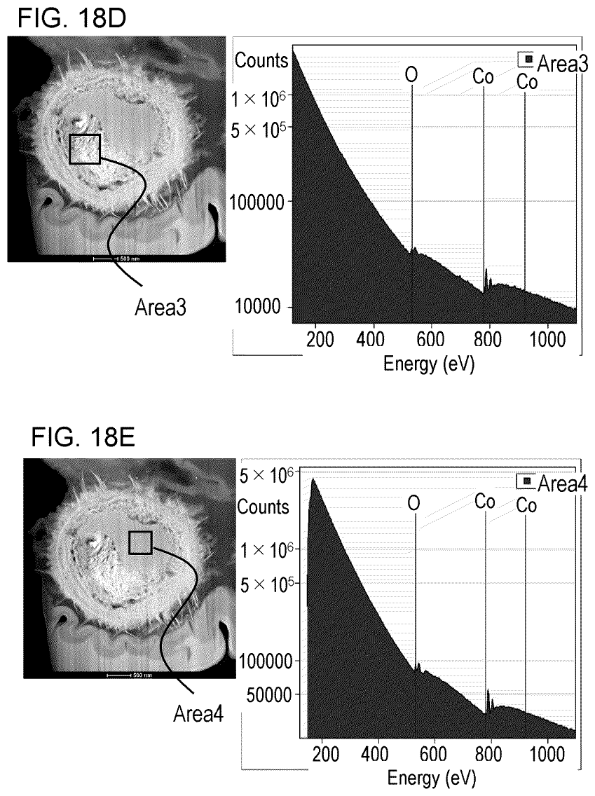

FIGS. 17A and 17B show the results of thermogravimetry-mass spectrometry (TG-MS) measurements. FIG. 17A shows the measurement results for a mixed sample of LCO particles and resin base material. FIG. 17B shows the measurement results obtained when the resin base material alone was used as the sample. Around 300° C., where the resin base material begins to lose weight, an increase in the number of molecules with a molecular weight of 28, believed to be carbon monoxide (CO), a reducing gas, is confirmed. In FIG. 17B, the amount of CO tends to increase up to around 500° C. (solid line in FIG. 17B), whereas in FIG. 17A, the amount of CO tends to decrease just before 400° C. (solid line in FIG. 17A). Near 500° C. in FIG. 17A, a decrease in the number of molecules with a molecular weight of 32, believed to be oxygen, is confirmed (dashed line in FIG. 17A), and an increase in the number of molecules with a molecular weight of 44, believed to be carbon dioxide, is confirmed (dotted line in FIG. 17A). Based on the TG and TG-MS results, the following is inferred.

As the temperature rises, the resin base material begins to lose weight (around 300° C.), generating the reducing gas CO, increasing reducibility. Some of the generated CO contributes to the reduction of the LCO particles. Therefore, it is believed that the LCO particles are reductively decomposed and transformed into particles P1r, which are the LCO particles having some gaps within them (FIG. 15B).

Meanwhile, since the amount of CO generated decreases as the base material loses weight, the reductive decomposition gradually becomes more difficult. As the base material weight continues to decrease, the influence of CO decreases, and oxidation becomes dominant over reduction for the LCO particles. The reduced particles P1r are oxidized again and changed to LiCoO₂ with trivalent Co (around 500° C.). It is believed that at this time the particles change to the LCO particles that retain the gaps P1d generated during reductive decomposition within the LCO particles, while having a core portion Pla, a shell portion P1b, and radially protruding protrusion portion Plc on the surface of the shell portion.

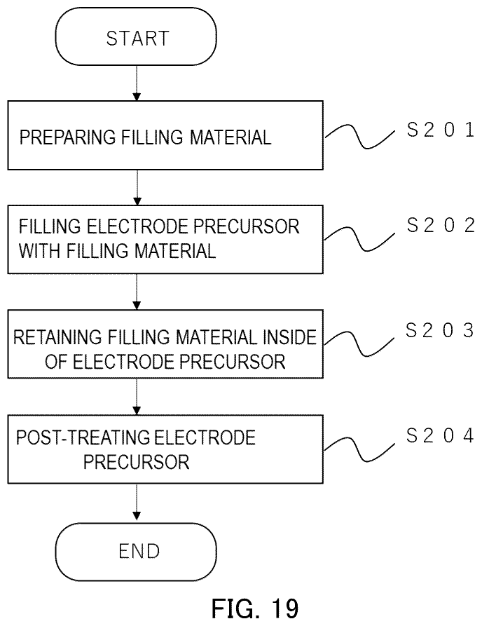

FIGS. 18B to 18E show STEM-EELS results (FIGS. 18B to 18E) for the LCO particle (FIG. 18A) after Step 3, at each of the regions shown in FIGS. 18B to 18E. It can be confirmed that the core portion Pla (Area 4 in FIG. 18E), shell portion P1b (Area 2 in FIG. 18C), and protrusion portion Plc (Area 1 in FIG. 18B) of the LCO particle contain Co and are composed of oxides with substantially similar compositions.

### Step 4

Step 4 is a step of post-treating the three-dimensional object obtained in Step 3. This post-treatment facilitates the filling of the electrode precursor with the filling material in the filling step (Step 2-1) described below.

In addition to the pressurization step described below, post-treatment can also include physical treatment and chemical treatment performed to improve wettability and filling properties. Known methods can be used. Specifically, physical treatment can be exemplified by laser edging of the three-dimensional object. Other examples include surface modification using UV irradiation or corona discharge, and chemical treatment such as gas adsorption. The pressurization step is described hereinbelow by way of example.

For example, Step 4 is a step of pressurizing the three-dimensional object 16 that was obtained in Step 3 and from which the resin base material has been removed (FIG. 12). The three-dimensional object 16 may be pressurized using the pressurizing means 422 while cooling or dissipating heat after heating. Alternatively, after removing the resin base material using a sintering processing device, the object may be separately pressurized using a pressurization device. While the pressurization method is not particularly limited, the preferred examples thereof include vacuum degassing, isostatic pressing, and pressurization with a general hydraulic press or a roller press. Among these, pressurization by a combination of vacuum degassing and isostatic pressing is particularly preferred. Furthermore, Step 4 is preferably performed by laminating the three-dimensional object with a release material such as a nichrome foil, and it is more preferable that Step 4 be performed by packaging the three-dimensional object in a laminate film.

The pressure during pressurization is preferably 5 MPa to 500 MPa. Pressurization reduces the size of the pores (voids) within the three-dimensional object from which the resin base material has been removed. As is generally known from capillary action, as pore size decreases, the permeation of liquid is facilitated. Therefore, post-treatment using pressurization further improves the filling properties of the filling material during the step for filling the filling material that is described below. Post-treatment using pressurization can also facilitate mutual contact between the particles that constitute the three-dimensional object. As a result, the ionic conductivity and electronic conductivity and the strength of the three-dimensional object are improved.

After Step 4, the heat treatment may be performed again to increase the compactness and strength of the three-dimensional object. In this case, the sintering processing device used in Step 3 may be used, or sintering may be performed separately using an electric furnace, a tubular furnace, a hot press, a hot isostatic pressing (HIP) device, etc.

The electrode precursor obtained through Step 1 to Step 4 contains active material particles and electrolyte particles and has voids. “Voids” refers to, for example, the spaces between the active material particles and the electrolyte particles. Having voids allows for filling with the filling material, as described below. The void ratio in the electrode precursor may be 1% by volume to 30% by volume, or 5% by volume to 20% by volume.

Where there are few voids, it is difficult for the filling material to fill the electrode precursor during the step for filling the filling material described below, and the effects of the filling material are unlikely to be demonstrated. Meanwhile, where the number of voids is large, contact between the active material particles and electrolyte particles may be insufficient, potentially reducing the ionic conductivity and electronic conductivity within the electrode. The void ratio can be determined using a so-called 3D-SEM, in which continuous cross-sectional images are acquired by repeatedly performing cross-sectional processing (FIB) and SEM observation and then reconstructed using analysis software to obtain a three-dimensional image. For a square 50 μm×50 μm region of the electrode, cross-sectional processing and SEM observation are repeated every 0.1 μm in the lamination direction to acquire a 50 μm×50 μm×10 μm three-dimensional image, and the void ratio is calculated. The void ratio can also be determined from a two-dimensional BIB-SEM image of the positive electrode cross section. At this time, an SEM image of a 500 μm×10 μm region including the center of the positive electrode cross section may be acquired, and the void ratio may be calculated. This can be calculated as the ratio of voids (pixels) to the entire image (pixels) by using commercially available image analysis software (Photoshop (registered trademark).

### Method for Manufacturing Electrode

Below, an example of a method for manufacturing an electrode is described in detail with reference to the drawings. An electrode can be configured as a positive electrode by using a positive electrode precursor as the electrode precursor. Also, a negative electrode can be obtained by using a negative electrode precursor as the electrode precursor.

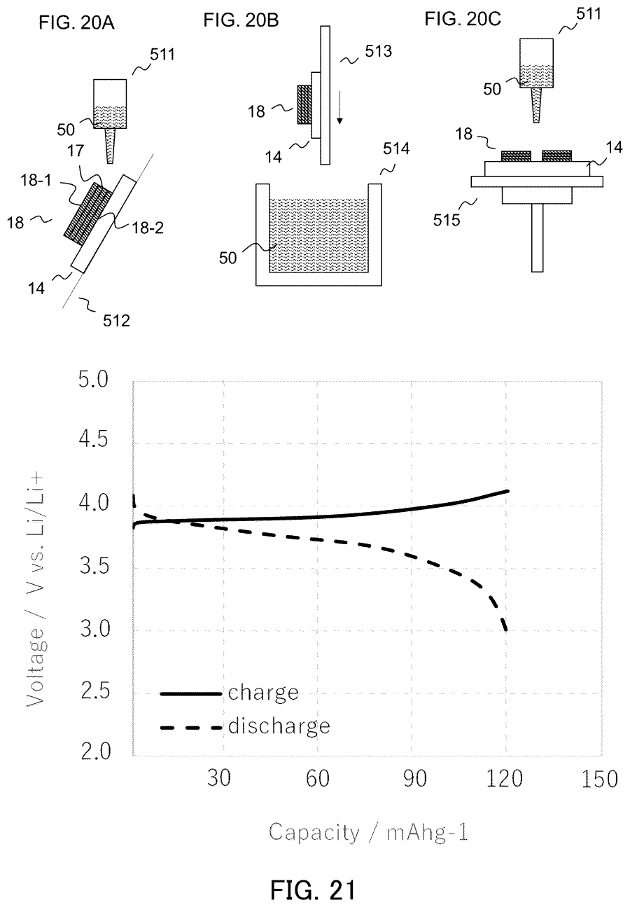

The method for manufacturing an electrode according to the present disclosure includes the following four steps (Step 1-1, Step 2-1, Step 3-1, and Step 4-1). It may also include Step 5-1. Here, the order of Step 1-1 and Step 2-1 is not particularly limited; Step 2-1 may be performed after Step 1-1, or Step 1-1 may be performed after Step 2-1. FIG. 19 is an illustration of the method for manufacturing an electrode.
(1) Step 1-1 (not shown) of preparing an electrode precursor containing active material particles and having voids between the active material particles.
(2) Step 2-1 (S201 in FIG. 19) of preparing a filling material to be filled into the electrode precursor.
(3) Step 3-1 (S202 in FIG. 19) of filling the electrode precursor from the outside to the inside with the filling material.
(4) Step 4-1 (S203 in FIG. 19) of retaining the filling material filled into the inside of the electrode precursor inside the electrode precursor.
(5) Step 5-1 (S204 in FIG. 19) of post-treating the electrode precursor obtained in Step 4-1.

### Step 1-1

Step 1-1 is a step of preparing an electrode precursor containing active material particles and having voids between the active material particles. Step 1-1 is not particularly limited as long as an electrode precursor can be prepared. For example, the electrode precursor can be prepared using the method for manufacturing an electrode precursor described above. That is, Step 1-1 preferably includes Step 1 of forming a particle layer containing active material particles and electrolyte particles on a resin base material having an adhesive portion, Step 2 of molding a laminate in which a plurality of the resin base materials on which the particle layer has been formed is laminated, Step 3 of removing the resin base material from the laminate and molding a three-dimensional object containing active material particles and electrolyte particles, and Step 4 of post-treating the three-dimensional object.

### Step 2-1

Step 2-1 is a step of preparing a filling material to be filled into the electrode precursor. Step 2-1 can be exemplified by a step of blending and preparing the following raw materials. As described above, the filling material needs to be liquid in order to fill the voids in the electrode precursor. The filling material may be, for example, a solution of at least one selected from the group consisting of a conductive resin and a conductive resin precursor dissolved in a solvent, or a dispersion of at least one selected from the group consisting of a conductive resin and a conductive resin precursor dispersed in a dispersion medium.

Examples of conductive resin precursors include monomers, oligomers, and polymers of thermosetting resins and photocurable resins. In other words, a conductive resin is preferably a cured product of a conductive resin precursor. Specific examples of conductive resin precursors include ionic compounds having structures corresponding to the structures represented by formulas (1) to (6), the polyols mentioned above, and the isocyanate compounds mentioned above.

Examples of filling materials include mixtures of the following raw materials:
At least one selected from the group consisting of a conductive resin and a conductive resin precursor.
Optionally, a supporting electrolyte such as a lithium salt.
A solvent or dispersion medium
Optionally, a conductive additive

The solvent or dispersion medium is not particularly limited, and for example, an organic solvent can be used. Examples of organic solvents that can be used include alcohols such as methanol and ethanol, ketones such as methyl ethyl ketone, acetone, and acetylacetone, and hydrocarbon solvents such as hexane and cyclohexane. Methyl ethyl ketone is particularly preferred.

The filling material may contain a supporting electrolyte. By including a supporting electrolyte in the filling material, the conductive resin in the electrode can contain the supporting electrolyte. The above-mentioned supporting electrolytes and conductive additives can also be used.

### Step 3-1

Step 3-1 is a step of filling the electrode precursor from the outside to the inside with the filling material prepared in Step 2-1. A known liquid filling method can be used as the filling means. The filling means preferably includes, for example, an application step of applying the filling material to the electrode precursor, and a permeation step of causing the applied filling material to permeate into the interior of the electrode precursor. Furthermore, it is more preferable to include a permeation step of causing the filling material to permeate into the electrode precursor so that the filling material contacts the inner surfaces of the active material particles, or a permeation step of causing the filling material to permeate into the electrode precursor so that the filling material contacts the outer surfaces of the active material particles. Examples of devices used in the application step include an inkjet device, a dispenser device, a dip coater, a spin coater, a spray coater, and a roll coater. Of these, a dispenser device is preferred. Examples of devices used in the permeation step include a vacuum dryer and a vacuum packaging machine. Pressure may be applied using a weight or the like to support the permeation.

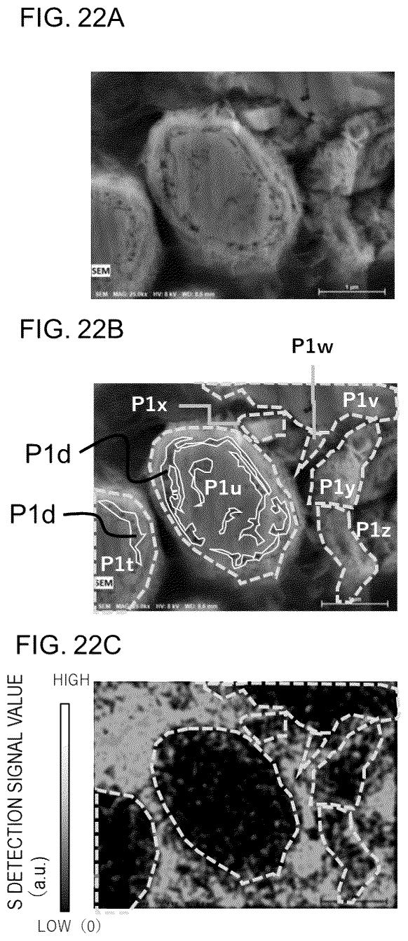

FIG. 20A is a schematic diagram showing the filling process using a dispenser device 511. A filling material 50 is accommodated in a syringe in the dispenser device 511 and applied to an electrode precursor 18 through a nozzle at the tip of the syringe. Meanwhile, the electrode precursor 18 that has been molded on the base material 14 (electrode current collector or solid electrolyte sheet) is fixed to a support table 512.

Here, the filling material may be applied to a surface 18-1 (hereinafter also referred to as the particle arrangement surface) opposite a surface 18-2 (hereinafter also referred to as the base material support surface) of the electrode precursor 18 that contacts the base material 14, or to an end portion 17 of the electrode precursor 18. However, it is preferable that the filling material be applied to the end portion 17. The reason for this will be explained hereinbelow. The end portion refers to the xz surface and the yz surface when the base material surface of the electrode precursor is the xy surface and the lamination direction is the z direction (FIG. 13B).

In Step 3, the resin base material is removed from the laminate to mold the electrode precursor 18 into a three-dimensional object. Therefore, the electrode precursor 18 has pores that communicate with the particle arrangement surface 18-1. Also, pores that communicate with the end portion 17 are provided. This facilitates uniform permeation of the filling material 50 into the entire electrode precursor 18. As a result, the conductive resin is more likely to be positioned so as to be in contact with the inner surfaces of the active material particles. Also, the conductive resin is more likely to be arranged so as to be in contact with the outer surfaces of the active material particles and to connect the active material particles to each other.

Furthermore, at the end portion, the interlayer spaces of the laminate structure of the electrode precursor are exposed. Therefore, when the filling material is applied to the end portion, the filling material is more likely to fill the interior.

Meanwhile, when applying the filling material 50 from the particle arrangement surface 18-1 of the electrode precursor 18, i.e., from the xy surface, it is preferable to apply small amounts of the filling material to a plurality of locations on the xy surface to ensure even permeation.

FIG. 20B is a schematic diagram showing the filling process using a dip coater 513. The filling material 50 is accommodated in a dipping container 514. As the dip coater 513 moves in the direction of the arrow, the filling material 50 is applied to the end portion of the electrode precursor 18.

FIG. 20C is a schematic diagram showing the filling process using a spin coater 515. The filling material 50 is accommodated in a syringe in a dispenser device 511 and applied to the resin base material 14 through the nozzle at the tip of the syringe. Meanwhile, the electrode precursor 18 molded on the resin base material 14 (electrode current collector or solid electrolyte sheet) is fixed to the support table of the spin coater 515. The filling material 50 applied to the resin base material 14 is applied to the end portion of the electrode precursor 18 by the centrifugal force of the spin coater 515.

### Step 4-1

Step 4-1 is a step of retaining the filling material, which has been filled inside the electrode precursor in Step 3-1, inside the electrode precursor. The retention means is not particularly limited and can be selected, as appropriate, depending on the filling material. Examples include a step of thickening the filling material and a step of curing the filling material. Specifically, when a thermosetting polymer electrolyte is used as the filling material, known means such as a vacuum oven can be used. When a UV-curable polymer electrolyte is used as the filling material, known methods such as a UV irradiation device can be used.

When using a UV irradiation device, depending on the thickness of the electrode, the filling material may not be cured easily with UV irradiation. In such cases, the thickness of the electrode precursor is adjusted to a thickness that allows the filled filling material to be cured easily, and a plurality of such electrode precursors is molded on a base with high releasability. After the filling material has been cured in each electrode precursor, an electrode can be obtained by transfer lamination.

Furthermore, the filling in Step 3-1 can be performed all at once or in small amounts in a plurality of steps. Specifically, when filling is performed in small amounts in a plurality of steps, an electrode may be obtained in the following manner. Thus, after performing filling of a small amount in Step 3-1 once, the filling material is retained inside the electrode precursor in Step 4-1. Then, filling in Step 3-1 is performed again, and the filling material is retained inside the electrode precursor in Step 4-1. In this way, Step 3-1 and Step 4-1 may be repeated to obtain an electrode precursor.

The electrode precursor obtained in Step 4-1 can be used as an electrode. It is also preferable to subject the electrode precursor obtained in Step 4-1 to Step 5-1 to produce an electrode.

### Step 5-1

Step 5-1 is a step of post-treating the electrode precursor obtained in Step 4-1 to obtain an electrode. The post-treatment can be exemplified by a pressurization step of pressurizing the electrode precursor obtained in Step 4-1, a buffer layer formation step of forming an interfacial buffer layer with the electrolyte on the surface of the electrode, and a packaging step of covering with a protective film or the like or performing vacuum packaging using an aluminum laminate film or the like to prevent peeling, cracking, or exposure to the atmosphere during transportation or storage.

Known pressurizing means can be used in the pressurization step. Specific examples thereof include vacuum degassing, isostatic pressing, and pressurization with a general hydraulic press or a roller press. Among these, pressurization by a combination of vacuum degassing and isostatic pressing is preferred.

Known coating methods can be used in the buffer layer formation step, specifically vacuum deposition, ion plating, sputtering, chemical vapor deposition (CVD), and the coating means of Step 3-1. A separately prepared buffer layer sheet (e.g., a polymer electrolyte sheet) can also be laminated without using the above-mentioned means. Alternatively, a buffer layer can be provided on the electrode by controlling the filling amount of the filling material filled in Step 3-1 in advance so that the filling material filled in Step 3-1 also serves as a buffer layer.

### Method for Manufacturing Secondary Battery

A secondary battery can be manufactured using the method for manufacturing an electrode described hereinabove. A method for manufacturing a secondary battery is not particularly limited, but the specific examples thereof are presented hereinbelow.

Here, the case is explained in which the above-described method for manufacturing an electrode is used to manufacture a positive electrode or a negative electrode. Using a current collector or an electrolyte that is formed by a separate method as a base, a positive electrode, a negative electrode, or both a positive electrode and a negative electrode can be manufactured using the method for manufacturing an electrode described above.

A secondary battery can be manufactured by laminating electrodes, current collectors, and electrolytes, optionally packaging the laminate with an aluminum laminate film or the like, and then molding and pressurizing. That is, the method for manufacturing a secondary battery may include a step of laminating electrodes, current collectors, and electrolytes. The electrodes described above can be used as electrodes.

Furthermore, the method for manufacturing a secondary battery may include a step of preparing an electrode using the method for manufacturing an electrode described above and a step of providing the prepared electrode together with a solid electrolyte adjacent to the electrode. In addition, the method for manufacturing a secondary battery may include a step of providing the electrode described above and the adjacent solid electrolyte together in the same step. That is, the electrode and the solid electrolyte may be prepared in separate steps, or they may be prepared together in the same step.

Here, a separate means for molding the electrolyte may be a known means, for example, such as a means for pelletizing electrolyte particles using a uniaxial press or the like and sintering in an electric furnace or the like.

A secondary battery can be manufactured by laminating the manufactured components in the following order: positive electrode current collector, positive electrode, electrolyte, negative electrode, and negative electrode current collector. Examples of secondary batteries include a laminate-type battery packaged in a laminate film and a coin-type battery packaged in a coin case.

The particles that make up the positive electrode, electrolyte, and negative electrode may have different optimal temperatures or atmospheres for sintering. When handling such materials, it is preferable to manufacture the positive electrode, electrolyte, and negative electrode components separately and assemble them into a battery. Furthermore, when using lithium metal or indium as the negative electrode, it is preferable to use the negative electrode as a metal foil or to mold the current collector and electrolyte using a vacuum process such as sputtering. Because lithium metal has strong reducing power, it is prone to decomposition depending on the type of solid electrolyte. In this case, a buffer layer may be provided between the electrode and the electrolyte. A polymer electrolyte or the like is preferably used as the buffer layer.

A specific example of the above-mentioned method for manufacturing a secondary battery uses the above-mentioned method for manufacturing an electrode to mold a positive electrode or negative electrode laminate and manufacture an electrode by using a current collector or electrolyte as a base.

Meanwhile, a laminate containing two or more selected from the group consisting of a positive electrode current collector, a positive electrode, an electrolyte, a negative electrode, and a negative electrode current collector, which are the main components of a secondary battery, can also be molded to produce a three-dimensional object containing an electrode.

For example, each base material is prepared using the particle arrangement device 1. The base materials are a positive electrode current collector base material, a positive electrode base material, an electrolyte base material, a negative electrode base material, and a negative electrode current collector base material. Each base material may contain a plurality of types of particles (e.g., positive electrode active material particles and electrolyte particles in the case of a positive electrode base material), or only a single type of particle. When only a single type of particle is contained, using the same type of filling agent in the filling devices 24a and 24b allows a single type of dense particle layer to be formed on the base material.

The electrolyte base material is formed from a particle layer containing electrolyte particles. The negative electrode base material is formed from a particle layer containing negative electrode active material particles. The current collector base material is formed from a particle layer containing conductive particles. These base materials are laminated in the following order using a laminate molding device: positive electrode current collector base material, positive electrode base material, electrolyte base material, negative electrode base material, and negative electrode current collector base material, thereby preparing a laminate. A three-dimensional object containing electrodes can then be molded using a sintering processing device to obtain a secondary battery precursor containing an electrode precursor. A secondary battery can be manufactured by filling and retaining a filling material in the electrode precursor (Steps 2-1 to 4-1).

Furthermore, a bipolar secondary battery can be manufactured in a similar manner, with a positive electrode and a negative electrode laminated on both sides of a current collector base material. In this case, the filling material is filled and retained in at least the electrodes, but it may also be filled and retained in the electrolyte or current collector other than the electrodes.

### Electrode Composite

An electrode composite includes an electrode of the present disclosure and an electrolyte layer that exchanges an active material with the electrode. By further providing a positive electrode or negative electrode to such an electrode composite, it is possible to configure a secondary battery in which expansion and contraction of active material particles can be mitigated and a decrease in battery output can be suppressed.

### Secondary Battery

A secondary battery includes a positive electrode of the present disclosure and an electrolyte layer that exchanges an active material with the positive electrode. The secondary battery also includes a negative electrode that exchanges the active material with the electrolyte layer. With such a secondary battery, expansion and contraction of active material particles can be mitigated and a decrease in battery output can be suppressed. Furthermore, by using a solid electrolyte such as an ion-conductive solid as the electrolyte layer, the secondary battery can be configured as an all-solid-state battery.

A method for manufacturing a secondary battery is not particularly limited, but the manufacturing method described above can be used.

### EXAMPLES

The present disclosure will be described in more detail below using examples, but the present disclosure is not limited to these examples. In the following examples, parts are by weight unless otherwise specified.

### Example 1

### Production Example of Positive Electrode

### Production Example of Positive Electrode Precursor

A positive electrode precursor according to Example 1 was molded using the method for producing an electrode precursor described above.

First, using the particle arrangement device 1 shown in FIG. 2, a particle layer consisting of positive electrode active material particles (first particles P1) and electrolyte particles (second particles P2) was formed on a resin base material provided with an adhesive portion (Step 1).

The first particles P1 were LiCoO₂ (hereinafter referred to as LCO), and the second particles P2 were Li₃BO₃ (hereinafter referred to as LBO). The LCO used was manufactured by Nippon Chemical Industrial Co., Ltd. (Cellseed C-5H), and the LBO used was manufactured by Toshima Manufacturing Co., Ltd.

The first base material 11a was a PDMS (ultraviolet-curable liquid silicone rubber) sheet having a protrusion-depression structure on the surface. The second base material 11b was a polyester (PET) resin sheet with adhesive portions coated with an acrylic adhesive on both sides. The thickness of the second base material 11b (PET) used was 3 μm. The thickness of the adhesive portion was 1 μm. LCO particles were arranged in a honeycomb pattern on the resin sheet, with LBO particles arranged in regions without LCO particles (FIG. 9B).

Step 2 was carried out using the resin base material with a particle layer formed thereon that was obtained in Step 1. That is, a laminate was molded by using a laminate molding apparatus U3 shown in FIG. 11 and laminating (lamination of three layers) the resin base material with a particle layer formed thereon on a current collector AC-1 (Al foil).

Then, using the sintering processing device U4 shown in FIG. 12, the resin base material was removed from the laminate by heating, thereby molding a three-dimensional object (Step 3). The sintering atmosphere was air, the sintering temperature was 510° C., and the sintering time was 1 h.

The three-dimensional object, laminated with a release agent (nichrome foil), was packaged in a laminate film (co-pack) and vacuum-packed using a vacuum packaging machine. The vacuum-packed laminate film was pressurized (196 MPa) for 1 min using an isostatic pressurization device to obtain a positive electrode precursor (Step 4).

### Preparation Example of Filling Material (Step 2-1)

### Production Example of Ionic Compound I-01

A stirrer and 60 ml of tetrahydrofuran (THF, manufactured by Kanto Chemical Co., Ltd.) were placed in an eggplant-shaped flask equipped with a Dimroth condenser. A total of 24.0 g (0.60 mol) of sodium hydride (60% by mass, dispersed in liquid paraffin, manufactured by Tokyo Chemical Industry Co., Ltd.) was dispersed in the eggplant-shaped flask, and the eggplant-shaped flask was cooled in an ice bath. A solution of 10.2 g (0.15 mol) of imidazole (manufactured by Tokyo Chemical Industry Co., Ltd.) dissolved in 60 ml of THF was slowly added dropwise, after which the ice bath was removed and stirring was performed for 2 h at room temperature. After adding 47.6 g (0.38 mol) of 2-bromoethanol (manufactured by Tokyo Chemical Industry Co., Ltd.) at room temperature, the mixture was heated to reflux at 70° C. for 7 h. After the reaction, the reaction liquid was filtered, the insoluble matter was washed away with THE, and the solvent of the resulting filtrate was evaporated under reduced pressure. The resulting product was dissolved in 200 ml of dichloromethane, and an aqueous solution containing 43.6 g (0.15 mol) of lithium bis(trifluoromethanesulfonyl)imide (manufactured by Tokyo Chemical Industry Co., Ltd.) was added as an anion source. The mixture was stirred at room temperature for 10 h. The resulting solution was fractionated to obtain an organic layer. This organic layer was washed three times with pure water. Next, dichloromethane was evaporated under reduced pressure to obtain ionic compound I-01. Ionic compound I-01 is represented by the following formula:

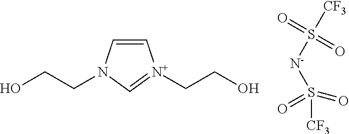 [SMILES: OCCn1cc[n+](CCO)c1 ; O=S(=O)([N-]S(=O)(=O)C(F)(F)F)C(F)(F)F]

### Production Example of Conductive Resin Precursor

A total of 120.5 parts by mass of polyether polyol (trade name: Adeka Polyol PR-5007, manufactured by ADEKA Corporation) was slowly added dropwise to 19.6 parts by mass of polymeric MDI (trade name: Millionate MR-200, manufactured by Tosoh Corporation) as an isocyanate in a reaction vessel under a nitrogen atmosphere, while maintaining the temperature inside the reaction vessel at 65° C. After the addition was completed, the components were allowed to react at 65° C. for 3.5 h. The resulting reaction mixture was cooled to room temperature, and 49.8 parts by mass of methyl ethyl ketone was added to obtain a solution of isocyanate-terminated prepolymer with an isocyanate group content of 2.5% by mass.

The following materials were stirred and mixed with 100 parts by mass of the resulting isocyanate group-terminated prepolymer solution to obtain a filling material.
Adeka Polyol PR-5007:113 parts by weight
Ionic compound I-1: 3.7 parts by weight
Supporting electrolyte (bis(trifluoromethanesulfonyl)imide lithium (manufactured by Tokyo Chemical Industry Co., Ltd.)): 18.6 parts by weight
Methyl ethyl ketone: 175 parts by weight

Next, the positive electrode precursor obtained in Step 4 was filled with the prepared filling material, starting from a portion of the end surface located on the periphery of the positive electrode precursor, by using the application device shown in FIG. 20A (Step 3-1).

The positive electrode precursor filled with the filling material was heated in a vacuum oven (140° C.) for 1 h to cure the filling material into a conductive resin, thereby molding a positive electrode A-1 (Step 4-1). Samples with varying loading levels of filling material were prepared, and the BIB-SEM described above was used to determine the appropriate level of conductive resin permeation within the electrode.

A secondary battery was fabricated using the molded positive electrode A-1. The fabrication method is explained below. Besides the positive electrode A-1, an electrolyte layer SE-1 and a negative electrode C-1 were prepared using the following method. The electrolyte layer SE-1 was an electrolyte sheet (260 μm thick) made by pelletizing Li_{1.5}Al_{0.5}Ge_{1.5}P₃O₁₂ (hereinafter referred to as LAGP) powder (manufactured by Toshima Manufacturing Co., Ltd.) using a uniaxial pressurizing device and sintering the pellets in an electric furnace (850° C./12 h). The negative electrode C-1 was an indium foil (50 μm thick, manufactured by The Nilaco Corporation).

The positive electrode current collector AC-1 (Al foil, 20 μm thick), positive electrode A-1, electrolyte layer SE-1, negative electrode C-1, and negative electrode current collector CC-1 (Cu foil, 20 μm thick) were laminated in this order, and the laminate was packaged in an aluminum laminate film so that a tab lead for a take-out electrode, which has been welded in advance to the current collector, was positioned outside the laminate. The laminate was then molded into a cell shape by using a vacuum packaging machine and pressurized (196 MPa) for 1 min by using an isostatic pressure machine to produce a secondary battery SB-1.

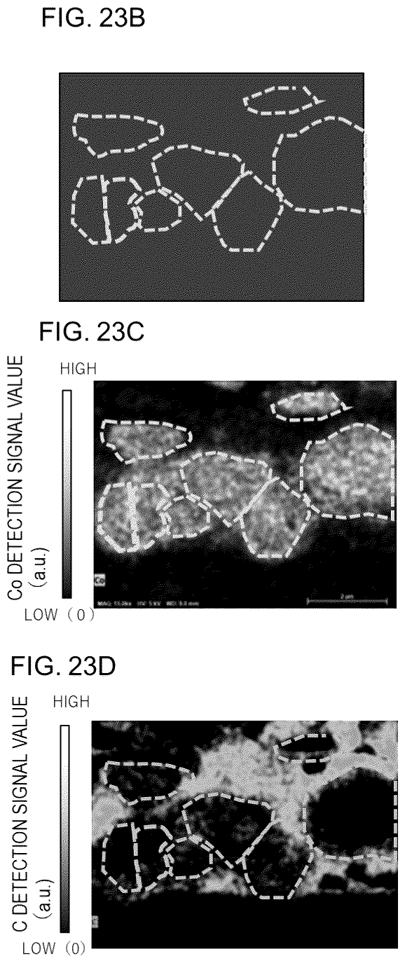

FIGS. 22A to 22D are electron microscope images of the cross section of the positive electrode A-1, taken using the method described below. FIG. 22A is an electron microscope image. In FIG. 22B, LCO particles (P1t, P1u, P1v, P1w, P1x, P1y, P1z) are identified based on an EDX image (element Co), with particle boundaries indicated by dashed lines. An LCO particle has a core portion Pla, a shell portion P1b, and a radially protruding protrusion portion Plc on the surface of the shell portion. Furthermore, a gap P1d is present between the core and shell portion (FIGS. 14A and 14B). In FIG. 22B, the boundaries of the gaps P1d within the particles P1t and P1u are indicated by solid lines. In other words, the solid lines can also be said to represent the inner surfaces of the active material particles.

FIG. 22C is an EDX image of sulfur element derived from the conductive resin. As in FIG. 22B, particle boundaries are indicated by dashed lines. The conductive resin is present in contact with the inner surfaces of the gaps P1d, i.e., the inner surfaces of the active material particles. Furthermore, the conductive resin contacts the outer surfaces of the LCO particles and is arranged to connect the LCO particles.

FIG. 22D is an EDX image of boron element derived from the solid electrolyte LBO. As in FIG. 22B, particle boundaries are indicated by dashed lines. As can be seen from FIGS. 22C and 22D, the conductive resin and inorganic electrolyte are unevenly distributed between the LCO particles.

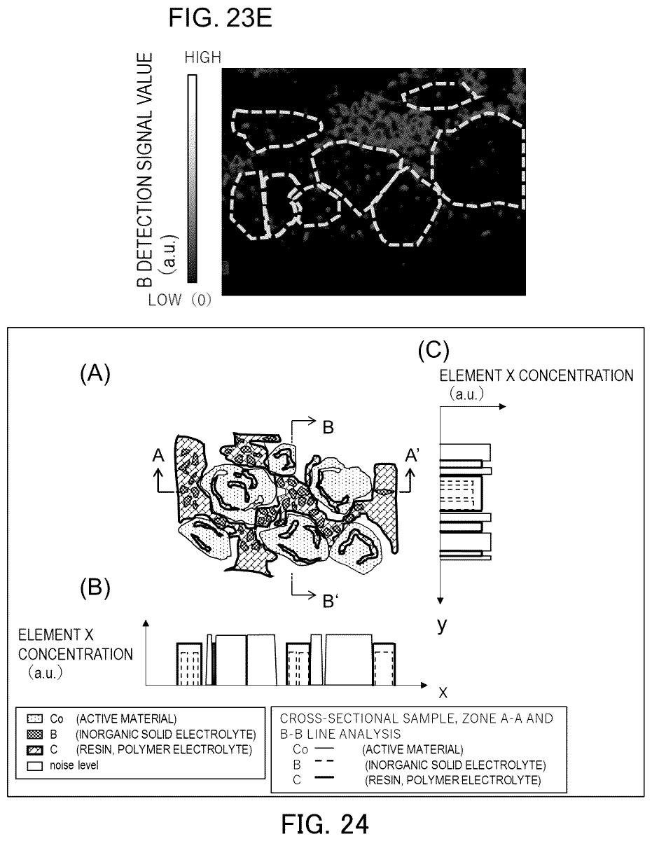

FIGS. 23A to 23E are low-magnification electron microscope images of the cross section of positive electrode A-1. FIG. 23A is an electron microscope image. In FIG. 23B, LCO particles are identified based on an EDX image (element Co), with particle boundaries indicated by dashed lines. FIG. 23C is an EDX image (element Co), FIG. 23D is an EDX image (element C), and FIG. 23E is an EDX image (element B). In FIGS. 23C to 23E, LCO particle boundaries are indicated by dashed lines. A conductive resin is present in contact with the inner surfaces of the gaps P1d, i.e., the inner surfaces of the active material particles. The conductive resin is also in contact with the outer surfaces of the LCO particles, connecting the LCO particles. Furthermore, the conductive resin is present so as to overlap the region containing LBO.

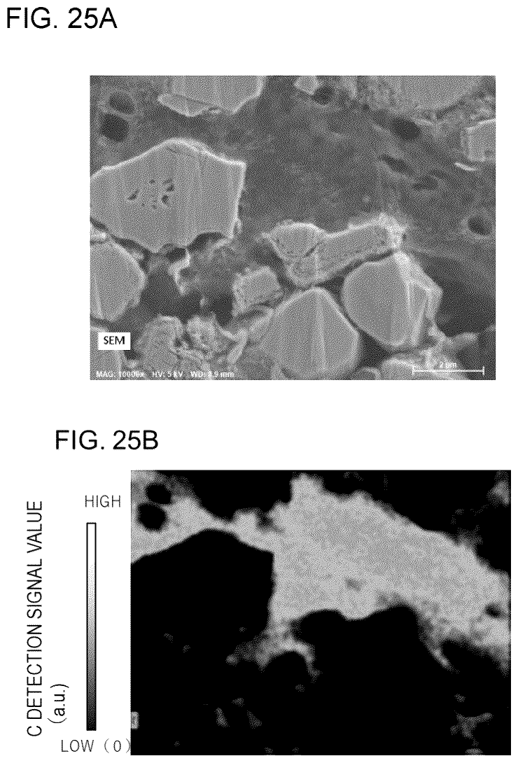

FIG. 24 is a schematic diagram illustrating features of the present disclosure, for example, in Example 1. In FIG. 24, (A) is a schematic diagram of an electrode, and (B) shows the EDX element distribution along line A-A′ in (A). (C) shows the EDX element distribution along line B-B′ in (A).

As shown in FIG. 24, the conductive resin is arranged to be in contact with the outer surfaces of the active material particles, connecting the active material particles. It is believed that the conductive resin forms a good interface with both the active material particles and the supporting electrolyte particles, improving ion diffusion within the electrode.

Furthermore, it is believed that the conductive resin changes shape in response to the expansion and contraction of the active material particles during charge and discharge, thereby suppressing a decrease in ionic conductivity and electronic conductivity. In addition, it is believed that the voids within the electrode function as space for deformation, including enlargement and shrinkage of the conductive resin, in response to the expansion and contraction of the active material particles.

Furthermore, the conductive resin fills the gaps P1d within the LCO particles. That is, the conductive resin is positioned so as to contact the inner surface of the LCO particles. In this way, the conductive resin forms a good interface with the LCO particle surface having the protrusion portion Plc, and also forms a good interface with the gaps P1d within the LCO particles, which is believed to further improve ion diffusion within the electrode. Furthermore, since the LCO particles are filled with the flexible conductive resin, the conductive resin changes shape in response to the expansion and contraction of the active material particles during charge and discharge. As a result, it is believed that a decrease in ionic conductivity and electronic conductivity within the particles is suppressed. Furthermore, it is thought that the conductive resin that is in contact with the inner and outer surfaces of the active material particles, so as to connect discontinuities within the particles (for example, cracks and gaps) and discontinuities between the particles (for example, voids), deforms in response to enlargement and shrinkage of the active material particles during charging and discharging, thereby maintaining ionic conductivity.

### Cross-Sectional Observation of Positive Electrode

To observe the cross section of the positive electrode, the battery was disassembled so as to be separated in the lamination direction and the positive electrode was removed. The removed positive electrode was cut with a wire saw (DWS3400, wire diameter 170 μm, diamond diameter 30 μm). The cut surface was cross-sectionally processed with a broad ion beam of Ar (SM-09010 Cross Section Polisher, manufactured by JEOL Ltd.). The cross-sectional processing conditions were a voltage of 6 kV and a current of 150 to 200 mA.

The cross section was photographed using an electron microscope (ULTRA 55) to obtain BIB-SEM images. The observation conditions were as follows:
Detector: ESB (backscattered electron beam)
Observation conditions: 3 kV accelerating voltage
Magnification: 1000×
Filter: ESB filter with 1500 V bias applied

Next, elemental mapping was performed using SEM-EDX (XFlash Detector 630M, manufactured by Bruker Co., Ltd.). From the elemental mapping results, active material particles, electrolyte particles, and conductive resin were identified.

The evaluation methods for secondary battery are described below.

### Charge/Discharge Characteristics, Capacity Retention Rate

The active material particle mass (M×number of layers×positive electrode area cm²) of the positive electrode was calculated from the active material particle mass M (g/cm²) per unit area of the resin base material on which the particle layer was formed. The active material particle mass M per unit area was determined as follows.

The weight of the first base material 11a was measured after filling it with the first particles P1 using the first filling device 24a in the particle arrangement device 1. Next, the weight of the first base material 11a was measured after transferring the aforementioned first particles P1 to the second base material 11b. The difference between the weights was calculated to determine the mass of the first particles P1 on the second base material 11b. The active material particle mass M per unit area was then calculated by dividing the mass of the first particles P1 by the area of the second base material 11b (the area of the protrusion-depression region).

Another calculation method is to use ICP atomic emission spectroscopy. Three levels of resin base materials on which particle layers with clarified active material particle mass M (g/cm²) per unit area have been formed are prepared in advance using the method described above or similar methods. These resin base materials are dissolved using microwave acid decomposition (ETHOS PRO), and the acid decomposition solutions are diluted with ultrapure water. ICP-AES measurement (CIROS CCD) is then performed to quantify the Co element. A calibration curve of the active material particle mass M (g/cm²) per unit area versus the obtained element concentration is obtained. From this calibration curve, it is possible to determine the active material particle mass M (g/cm²) per unit area of the resin base material on which the particle layer to be measured has been formed.

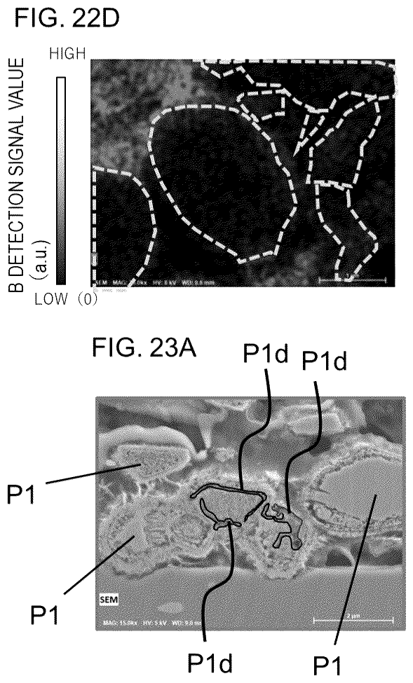

The current value at a current rate of 0.4 C was determined, and charge/discharge measurements (constant-current charge/constant-current discharge) were performed at a current rate of 0.4 C. Measurements were performed using a charge/discharge device (manufactured by BioLogic Science Instruments SAS). FIG. 21 shows the measured charge/discharge curve. The vertical axis represents the battery cell voltage (V vs. Li/Li⁺), and the horizontal axis represents the battery cell capacity (mAh/g). The capacity is the capacity per mass of the positive electrode active material.

The actual capacity of the LCO was 120 mAh/g, and the cutoff voltage (vs. Li) was 4.2 V (charge)/2.6 V (discharge). The capacity retention rate in this case is the ratio of the discharge capacity to the charge capacity (discharge capacity/charge capacity×100%). The above measurement was repeated five times, and the average value was calculated. A value of 80% or higher was considered good.

### Cycle Characteristics

A cycle evaluation (repeated charge/discharge measurement in constant current mode) was performed at a current rate of 0.4 C. Repeated charge/discharge measurements were performed with respect to the aforementioned capacity retention rate until the capacity retention rate reached 80% or less. The number of cycles n was determined, and a value of 10 or more was considered good.

The battery evaluation results showed a capacity retention rate of 100% and the number of cycles n of 12. If the charge/discharge and cycle characteristics were good according to the above evaluations, the battery was rated A (Table 1).

### Example 2

A positive electrode A-2 was fabricated in the same manner as in Example 1, except that the filling material was applied to the particle arrangement surface of the positive electrode precursor and then filled into the positive electrode precursor. A secondary battery SB-2 was fabricated in the same manner as in Example 1, except that the positive electrode A-2 was used.

When observing the cross section of the positive electrode A-2, the conductive resin was located in contact with the inner surface of the gap, similar to the positive electrode A-1. Furthermore, similar to the positive electrode A-1, the conductive resin was arranged in contact with the outer surface of the LCO particles, connecting the LCO particles. Furthermore, similar to the positive electrode A-1, the conductive resin overlapped the region containing LBO. Furthermore, the conductive resin and inorganic electrolyte were unevenly distributed between the LCO particles.

Furthermore, it was confirmed that the resulting secondary battery SB-2 had good capacity retention and cycle characteristics, similar to those of secondary battery SB-1.

### Example 3

A positive electrode A-3 was fabricated using the same method as in Example 1, except that the sintering temperature in Step 3 was changed from 510° C. to 700° C. A secondary battery SB-3 was fabricated using the same method as in Example 1, except that the positive electrode A-3 was used.

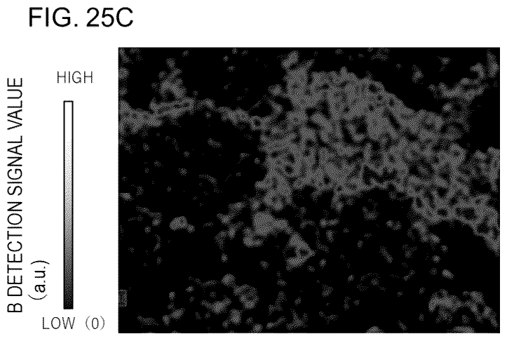

FIGS. 25A to 25C are electron microscope images of the cross section of the positive electrode A-3. FIG. 25A is an electron microscope image, FIG. 25B is an EDX image (element C), and FIG. 25C is an EDX image (element B). Perhaps due to the high-temperature sintering, oxidation of the LCO particles progressed, returning them to a form similar to that of the LCO particles of the raw material, and no gaps were observed.

In the cross-sectional structure of the resulting positive electrode A-3, the conductive resin was arranged in contact with the outer surfaces of the LCO particles, connecting the LCO particles. Furthermore, similar to the positive electrode A-1, the conductive resin was present so as to overlap the region containing LBO. In addition, the conductive resin and inorganic electrolyte were unevenly distributed between the LCO particles.

Furthermore, it was confirmed that the resulting secondary battery SB-3 had good capacity retention and cycle characteristics, similar to those of the secondary battery SB-1.

### Example 4

A positive electrode A-4 was fabricated in the same manner as in Example 1, except that the first particles were replaced with LCO particles (CellSeed C-8H) with a larger particle diameter. In cross-sectional observation of the positive electrode A-4, the conductive resin was located in contact with the inner surface of the gaps, similar to the positive electrode A-1. Furthermore, similar to the positive electrode A-1, the conductive resin was arranged in contact with the outer surface of the LCO particles, connecting the LCO particles. In addition, similar to the positive electrode A-1, the conductive resin was present so as to overlap the region containing LBO. Furthermore, the conductive resin and inorganic electrolyte were unevenly distributed between the LCO particles. Furthermore, it was confirmed that the resulting secondary battery SB-4 had good capacity retention and cycle characteristics, similar to those of the secondary battery SB-1.

### Example 5

A positive electrode A-5 was fabricated using the same method as in Example 1, except that pressure (50 MPa) was applied using the pressurizing means 422 in the sintering processing device U4. In cross-sectional observation of the positive electrode A-5, the conductive resin was located in contact with the inner surface of the gaps, similar to the positive electrode A-1. Furthermore, similar to the positive electrode A-1, the conductive resin was arranged in contact with the outer surface of the LCO particles, connecting the LCO particles. In addition, similar to the positive electrode A-1, the conductive resin was present so as to overlap the region containing LBO. Furthermore, the conductive resin and inorganic electrolyte were unevenly distributed between the LCO particles. Furthermore, it was confirmed that the resulting secondary battery SB-5 had good capacity retention and cycle characteristics, similar to those of the secondary battery SB-1.

### Example 6

A positive electrode A-6 was fabricated in the same manner as in Example 1, except that Li_{5.9}Yb_{0.81}La_{0.09}Zr_{0.1}(BO₃)₃ (LYbBO-1) was used as the electrolyte particles. A secondary battery SB-6 was also fabricated in the same manner as in Example 1, except that the positive electrode A-6 was used.

In cross-sectional observation of the positive electrode A-6, the conductive resin was located in contact with the inner surface of the gaps, similar to the positive electrode A-1. Furthermore, similar to the positive electrode A-1, the conductive resin was arranged in contact with the outer surface of the LCO particles, connecting the LCO particles. In addition, similar to the positive electrode A-1, the conductive resin was present so as to overlap the region containing LBO. Furthermore, the conductive resin and inorganic electrolyte were unevenly distributed between the LCO particles.

Furthermore, it was confirmed that the resulting secondary battery SB-6 had good capacity retention and cycle characteristics, similar to those of the secondary battery SB-1.

Table 1 is a comparison table summarizing the formulations and manufacturing conditions of Examples 1 to 6, along with the evaluation results.

TABLE 1

| | | | | Ratio of | | | | |
|---|---|---|---|---|---|---|---|---|
| | | | Pressurization | voids in | | | | |
| | Positive electrode | | in sintering | positive | | | Presence/ | |
| | raw materials | | processing | electrode | | | absence | |
| Example | First | Second | device U4, | precursor (% | Application | Contact | of uneven | Battery |
| No | particles | particles | Yes/No | by volume) | location | location | distribution | evaluation |
| 1 | LCO C-5H | LBO | No | 15 | End surface | Inner surface, | Present | A |
| | | | | | | outer surface | | |
| 2 | LCO C-5H | LBO | No | 15 | Particle | Inner surface, | Present | A |
| | | | | | arrangement | outer surface | | |
| | | | | | surface | | | |
| 3 | LCO C-5H | LBO | No | 15 | End surface | Outer surface | Present | A |
| 4 | LCO C-8H | LBO | No | 20 | End surface | Inner surface, | Present | A |
| | | | | | | outer surface | | |
| 5 | LCO C-5H | LBO | Yes | 5 | End surface | Inner surface, | Present | A |
| | | | | | | outer surface | | |
| 6 | LCO C-5H | LYbBO-1 | No | 15 | End surface | Inner surface, | Present | A |
| | | | | | | outer surface | | |

In the table, “application location” indicates the location where the filling material was applied to the positive electrode precursor in Step 3-1, “contact location” indicates the contact location between the conductive resin and the LCO particles, and “Presence/absence of uneven distribution” indicates whether the conductive resin and inorganic electrolyte were unevenly distributed.

The present disclosure can provide an electrode that can mitigate expansion and contraction of active material particles and suppress a decrease in battery output when used in a secondary battery. The present disclosure also provides an electrode composite including the electrode of the present disclosure. Additionally, the present disclosure provides a secondary battery in which a decrease in battery output is suppressed. Furthermore, the present disclosure provides a method for manufacturing an electrode with high reproducibility.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An electrode for use in a secondary battery, wherein
the electrode comprises an active material particle and a conductive resin,
the active material particle has an inner surface,
the conductive resin is positioned so as to contact the inner surface.

2. The electrode according to claim 1, wherein the conductive resin comprises a resin having ionic conductivity.

3. The electrode according to claim 1, wherein the conductive resin comprises
a resin having an ionic functional group, and
a supporting electrolyte.

4. The electrode according to claim 1, wherein the conductive resin comprises
a urethane resin having an ionic functional group, and
a supporting electrolyte.

5. The electrode according to claim 1, wherein the inner surface is continuous with an outer surface of the active material particle.

6. The electrode according to claim 5, wherein the conductive resin contacts the outer surface.

7. The electrode according to claim 1, wherein at least one selected from the group consisting of the conductive resin, a conductive additive, and a supporting electrolyte is contained between the active material particles.

8. The electrode according to claim 1, wherein the electrode comprises a supporting electrolyte between the active material particles,
the supporting electrolyte comprises an inorganic electrolyte.

9. The electrode according to claim 8, wherein a region in which the conductive resin is comprised between the active material particles overlaps a region comprising the inorganic electrolyte.

10. The electrode according to claim 1, wherein the active material particles comprise lithium cobalt oxide.

11. The electrode according to claim 5, wherein the active material particle has a protrusion portion protruding from the outer surface.

12. The electrode according to claim 1, wherein the conductive resin comprises at least one of a polyurethane, a polyacryl, and a polyether, in a main chain structure.

13. The electrode according to claim 1, wherein the conductive resin comprises a polyether being a copolymer of polyethylene glycol and polypropylene glycol, in a main chain structure.

14. The electrode according to claim 1, wherein the conductive resin has higher flexibility than the active material particle.

15. An electrode for use in a secondary battery, wherein
the electrode comprises an active material particle and a conductive resin,
the active material particle has an outer surface, and
the conductive resin contacts the outer surface and is arranged so as to connect the active material particles.

16. An electrode composite comprising an electrode and an electrolyte layer exchanging an active material with the electrode, wherein
the electrode is the electrode according to claim 1.

17. A secondary battery comprising a positive electrode and an electrolyte layer exchanging an active material with the positive electrode, wherein
the positive electrode is the electrode according to claim 1, and
the secondary battery comprises a negative electrode exchanging the active material with the electrolyte layer.

18. A method for manufacturing an electrode, comprising:
Step 1-1 of preparing an electrode precursor comprising active material particles and having gaps between the active material particles;
Step 2-1 of preparing a filling material to be filled into the electrode precursor;
Step 3-1 of filling the electrode precursor from an outside to an inside with the filling material; and
Step 4-1 of retaining the filling material filled into the inside of the electrode precursor inside the electrode precursor.
